(19) United States
(12) Patent Application Publication
(10) Pub. No.: US 2018/0121817 A1
(43) Pub. Date: May 3, 2018

(54) SYSTEM AND METHOD FOR ASSISTING IN THE PROVISION OF ALGORITHMIC TRANSPARENCY

(71) Applicant: Carnegie Mellon University, Pittsburgh, PA (US)

(72) Inventors: Anupam Datta, Redwood City, CA (US); Shayak Sen, Pittsburgh, PA (US); Yair Zick, Singapore (SG)

(21) Appl. No.: 15/796,222

(22) Filed: Oct. 27, 2017

Related U.S. Application Data
(60) Provisional application No. 62/496,778, filed on Oct. 28, 2016.

(51) Int. Cl. G06N 5/04

(52) U.S. Cl. CPC G06N 5/046; G06N 5/048

(57) ABSTRACT

The subject disclosure relates to devices, systems, and methods for algorithmic transparency into algorithmic decision-making systems. In non-limiting aspects, the disclosed subject matter facilitates generating a set of intervention inputs for an algorithmic decision-making system, observing the outcomes of the algorithmic decision-making system, and determining Quantitative Input Influence (QII) measures for the algorithmic decision-making system, wherein the at least one QII measure describes degree of influence of inputs on outcomes of the algorithmic decision-making system. In further non-limiting aspects, the disclosed subject matter facilitates generating transparency reports related to the QII measures, including transparency reports, regarding inputs, regarding individuals, and regarding groups of individuals, while maintaining privacy. Further non-limiting embodiments are provided that illustrate the advantages and flexibility of the disclosed subject matter.

### CROSS-REFERENCE TO RELATED APPLICATIONS

This application claims priority to U.S. Provisional Patent Application Ser. No. 62/496,778, filed on Oct. 28, 2016, and entitled SYSTEM AND METHOD FOR ASSISTING IN THE PROVISION OF ALGORITHMIC TRANSPARENCY, the entirety of which is hereby incorporated by reference.

### GOVERNMENT RIGHTS

This invention was made with government support under CNS1064688 awarded by the National Science Foundation and FA8750-15-2-0277 awarded by the Air Force Research Laboratory. The government has certain rights in the invention.

### TECHNICAL FIELD

The subject disclosure is directed to machine learning and in particular to systems and methods that help to assess the decision making by machine learning systems and similar systems.

### BACKGROUND

Algorithmic decision-making systems (e.g., decision-making systems employing machine learning, etc.) and related statistical methods are becoming increasingly common. Such systems direct decisions, autonomously or semi-autonomously, in sectors as diverse as Web services, healthcare, education, insurance, law enforcement and defense. However, these decision-making processes of such systems are often opaque, and it is difficult to explain why a certain decision was made.

In addition, the desire for algorithmic transparency into algorithmic decision-making systems (e.g., decision-making systems employing machine learning, etc.) has grown in intensity as public and private sector organizations increasingly use large volumes of personal information and complex data analytics systems or models for such decision-making. While the importance of algorithmic transparency is recognized, work on computational foundations for this field has been limited.

For example, while causal models and probabilistic interventions have been studied, such examples may fail to enable transparency queries for data analytics systems ranging from classification outcomes of individuals to disparity among groups. Independently, there has been considerable work in the machine learning community to define importance metrics for variables, but mainly for the purpose of feature.

Quantitative Information Flow is concerned with information leaks and therefore needs to account for correlations between inputs that may lead to leakage. The dual problem of transparency, on the other hand, requires destroying correlations while analyzing the outcomes of a system to identify the causal paths for information leakage. An orthogonal approach to adding interpretability to machine learning is to constrain the choice of models to those that are interpretable by design. However, since the choice of models in this approach is restricted, a loss in predictive accuracy is a concern, and therefore, the central focus in this line of work is the minimization of the loss in accuracy while maintaining interpretability. In addition, experimentation on Web Services only has partial control of inputs, partial observability of outputs, and little or no knowledge of input distributions. The intended use of these experiments is to enable external oversight into Web services without any cooperation. Game theoretic measures have been used by various research disciplines to measure influence. Indeed, such measures are relevant whenever one is interested in measuring the marginal contribution of variables, and when sets of variables are able to cause some measurable effect, but fails to allow for the notion of influence to include a wide range of system behaviors, such as group disparity, group outcomes and individual outcomes.

The above-described deficiencies of algorithmic transparency techniques are merely intended to provide an overview of some of the problems of conventional systems and methods, and are not intended to be exhaustive. Other problems with conventional systems and corresponding benefits of the various non-limiting embodiments described herein may become further apparent upon review of the following description.

### SUMMARY

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

Thus, in non-limiting embodiments, the disclosed subject matter relates to software and services and, more specifically, relates to software and services facilitating algorithmic transparency into algorithmic decision-making systems and so on. In non-limiting embodiments, the disclosed subject matter facilitates generating a set of inputs (e.g., intervention inputs) for an algorithmic decision-making system, wherein the set of inputs (e.g., intervention inputs) can comprise an input intervention distribution based on a distribution of inputs of a population analyzed by the algorithmic decision-making system, in a non-limiting aspect. In a further non-limiting aspect, exemplary embodiments can facilitate determining one or more Quantitative Input Influence (QII) measures for the algorithmic decision-making system, wherein the one or more QII measures describe degree of influence of a subset of the set of inputs (e.g., intervention inputs) on an outcome that represents a property of a behavior of the algorithmic decision-making system for the input intervention distribution. Exemplary embodiment can further facilitate generate one or more transparency reports (e.g., influences/explanations) related to the one or more QII measures, wherein the one or more transparency reports (e.g., influences/explanations) can be based on one or more transparency queries (e.g., via an associated transparency query component) associated with the one or more QII measures.

In addition, further exemplary implementations are directed to devices and/or other articles of manufacture that facilitate algorithmic transparency into algorithmic decision-making systems, as further detailed herein. Such articles of manufacture as described herein as a tangible computer readable storage medium can include machine-executable instructions that can encode aspects of the relevant disclosed embodiments, that, in response to execution by a processor of a computing device, cause the computing device including the processor to perform operations associated with the disclosed embodiments.

These and other features of the disclosed subject matter are described in more detail below.

### BRIEF DESCRIPTION OF THE DRAWINGS

The devices, components, systems, and methods of the disclosed subject matter are further described with reference to the accompanying drawings in which:

FIG. 1 depicts a functional block diagram illustrating an exemplary environment suitable for use with aspects of the disclosed subject matter;

FIG. 2 depicts an illustrative aspect of algorithmic transparency regarding an exemplary algorithmic decision-making system directed to credit decisions;

FIG. 3 depicts another illustrative aspect of algorithmic transparency regarding an exemplary algorithmic decision-making system directed to credit decisions;

FIG. 4 depicts a functional block diagram illustrating an exemplary architecture according to non-limiting aspects of the disclosed subject matter;

FIG. 5 depicts a functional block diagram illustrating another exemplary architecture according to non-limiting aspects of the disclosed subject matter;

FIG. 6 depicts a functional block diagram illustrating yet another exemplary architecture according to further non-limiting aspects of the disclosed subject matter;

FIG. 7 depicts exemplary aspects of the disclosed subject matter, in which a QII measure for individual outcomes is demonstrated;

FIG. 8 tabulates a summary of exemplary QII measures described herein;

FIG. 9 depicts an exemplary histogram illustrating influences of features or inputs on outcomes, behaviors, or decisions associated with individuals;

FIG. 10 depicts an exemplary histogram of features or inputs on outcomes, behaviors, or decisions associated with individuals, for which various aspects can be provided in an exemplary transparency report, as described herein;

FIG. 11 depicts a functional block diagram illustrating exemplary non-limiting devices or systems suitable for use with aspects of the disclosed subject matter;

FIG. 12 depicts an exemplary non-limiting device or system suitable for performing various aspects of the disclosed subject matter;

FIG. 13 illustrates an exemplary non-limiting flow diagram of methods for performing aspects of embodiments of the disclosed subject matter;

FIG. 14 is a block diagram representing exemplary non-limiting networked environments in which various embodiments described herein can be implemented; and

FIG. 15 is a block diagram representing an exemplary non-limiting computing system or operating environment in which one or more aspects of various embodiments described herein can be implemented.

### DETAILED DESCRIPTION

As described above, while the importance of algorithmic transparency is recognized, work on computational foundations for this field has been limited. For example, while causal models and probabilistic interventions have been studied, such examples may fail to enable transparency queries for data analytics systems ranging from classification outcomes of individuals to disparity among groups. Further, such examples, fail to account for a notion of marginal contribution to compute responsibility.

For instance, use of interventions to assess the causal importance of relations between variables in causal graphs, in order to assess the causal effect of a relation between two variables, X→Y (assuming that both take on specific values X=x and Y=y), a new causal model can be constructed, where the value of X is replaced with a prior over the possible values of X. The influence of the causal relation can be defined as the Kullback-Leibler divergence of the joint distribution of all the variables in the two causal models with and without the value of X replaced. As described herein, an approach of the intervening with a random value from the prior can be employed for constructing X_{-S}.

Independently, there has been considerable work in the machine learning community to define importance metrics for variables, but mainly for the purpose of feature selection. One important metric is known as Permutation Importance, which measures the importance of a feature towards classification by randomly permuting the values of the feature and then computing the difference of classification accuracies before and after the permutation. Replacing a feature with a random permutation can be viewed as a sampling the feature independently from the prior as further described herein.

Literature on establishing causal relations, as opposed to quantifying them, can provides a mathematical foundation for causal reasoning and inference. For instance, measures of causal strength for individual binary inputs and outputs in a probabilistic setting have been studied. In addition, actual causation can be employed to derive a measure of responsibility as degree of causality, for example, as in defining the responsibility of a variable X to an outcome as the amount of change required in order to make X the counterfactual case. As described herein, the Deegan-Packel index can be understood to be related to causal responsibility.

As further described herein, various disclosed embodiments can be considered to be a causal alternative to quantitative information flow. Quantitative information flow is a broad class of metrics that quantify the information leaked by a process by comparing the information contained before and after observing the outcome of the process. Recent works have proposed measures for quantifying the security of information by measuring the amount of information leaked from inputs to outputs by certain variables. However, Quantitative Information Flow is concerned with information leaks, and therefore, it needs to account for correlations between inputs that may lead to leakage, as opposed to the problem of transparency, which requires destroying correlations while analyzing the outcomes of a system to identify the causal paths for information leakage.

An orthogonal approach to adding interpretability or transparency to machine learning is to constrain the choice of models to those that are interpretable by design (e.g., via regularization techniques that attempt to pick a small subset of the most important features, by using models that structurally match human reasoning such as Bayesian Rule Lists, Supersparse Linear Integer Models, or Probabilistic Scaling, etc.). Since the choice of models in this approach is restricted, a loss in predictive accuracy is a concern, and therefore, the central focus in this line of work is the minimization of the loss in accuracy while maintaining interpretability.

Moreover, systematic Experimentation on Web Services is an emerging body of work to enhance transparency into Web Services (e.g., targeted advertising, etc.). The setting in this line of work is different, because it has restricted access to analytics systems through publicly available interfaces. In addition, experimentation on Web Services only has partial control of inputs, partial observability of outputs, and little or no knowledge of input distributions. The intended use of these experiments is to enable external oversight into Web services without any cooperation.

Game theoretic measures have been used by various research disciplines to measure influence (e.g., game theoretic influence measures on graph-based games in order to identify key members of terrorist networks, identifying important members of large social networks, providing scalable algorithms for influence computation, assign importance to protein interactions in large, complex biological interaction networks, using a Shapley value in order to measure causal effects in neurophysical models, etc.). Indeed, such measures are relevant whenever one is interested in measuring the marginal contribution of variables, and when sets of variables are able to cause some measurable effect, but such approaches fail to allow for the notion of influence to include a wide range of system behaviors, such as group disparity, group outcomes and individual outcomes. Other game-theoretic influence measures used in various settings, for example, to define a measure for quantifying feature influence in classification tasks, does not account for the prior on the data, nor does it use interventions that break correlations between sets of features. Various embodiments described herein both accounts for interventions on sets and generalizes the notion of influence to include a wide range of system behaviors, such as group disparity, group outcomes and individual outcomes.

As further described herein, various disclosed embodiments can facilitate algorithmic transparency to provide several benefits. First, it is essential to enable identification of harms, such as discrimination, introduced by algorithmic decision-making (e.g., high interest credit cards targeted to protected groups) and to hold entities in the decision-making chain accountable for such practices. This form of transparency or accountability can enable or incentivize entities to adopt appropriate corrective measures, alter or improve models employed algorithmic decision-making systems, etc. Second, transparency can help detect errors in input data which resulted in an adverse decision (e.g., incorrect information in a user's profile because of which insurance or credit was denied). Detected errors can then be corrected. Third, by explaining why an adverse decision was made, algorithmic transparency can provide guidance on how to reverse it (e.g., by identifying a specific factor in the credit profile that needs to be improved), alter or improve models employed algorithmic decision-making systems, identify business opportunities such as under-served markets, etc.

As used herein, the terms, “decision-making systems,” “algorithmic decision-making systems,” “algorithmic systems,” “learning system,” “machine learning system,” “classifier,” “classifier systems,” and so on can be used interchangeably, depending on context, and can refer to and to one or more computer implemented, automated or semi-automated, decision-making processes or components, according to various non-limiting implementations, as described herein. As further used herein, the terms, “inputs,” “features,” and so on can be used interchangeably, depending on context, and can refer to data, information, and so on, used as inputs to one or more computer implemented, automated or semi-automated, decision-making processes or components, whereas the terms, “outputs,” “decisions,” “classifications,” “outcomes,” and so on can be used interchangeably, depending on context, and can refer to data, information, and so on resulting from one or more computer implemented, automated or semi-automated, decision-making processes or components based on the inputs, etc.

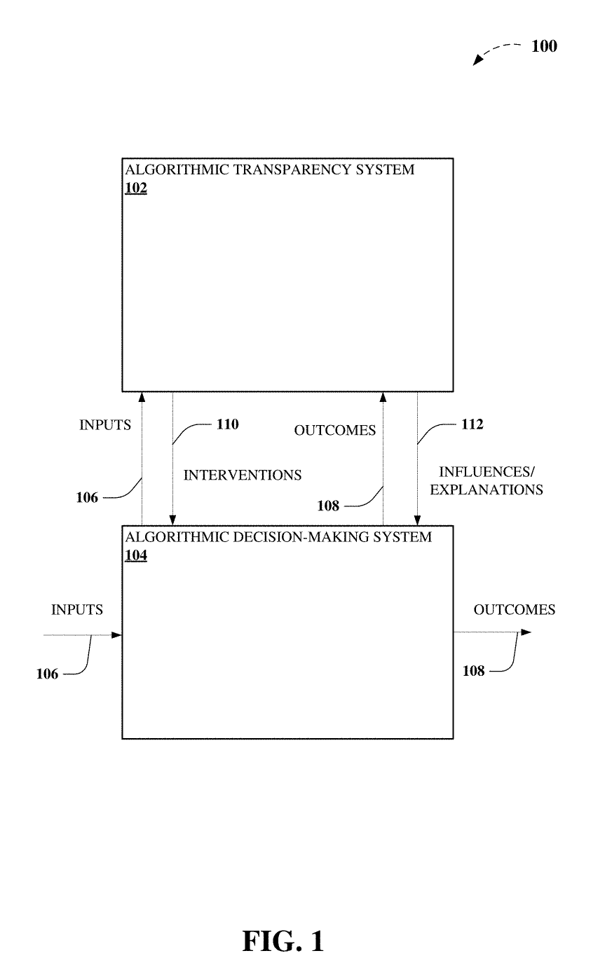

For example, FIG. 1 depicts a functional block diagram 100 illustrating an exemplary environment suitable for use with aspects of the disclosed subject matter. To these and related ends, in non-limiting embodiments of the disclosed subject matter, an exemplary algorithmic transparency system 102 can be operatively coupled to an exemplary algorithmic decision-making system 104 (e.g., via an application programming interface (API), a local area network (LAN), a wide area network (WAN), etc.), according to various aspects as described herein. For instance, exemplary algorithmic decision-making system 104 can be configured to process exemplary inputs 106, and on the basis of such inputs 106 and, for example, a decision-making algorithm or model, provide exemplary outcomes 108. However, as described above, decision-making processes of exemplary algorithmic decision-making system 104 may be opaque, or unintelligible, making difficult to explain why a certain decision was made.

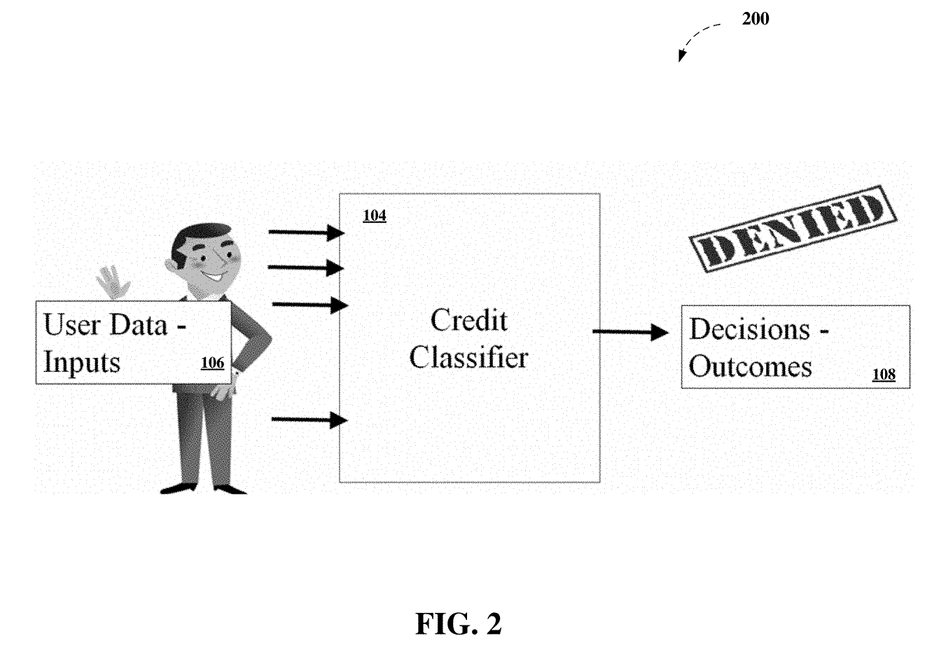

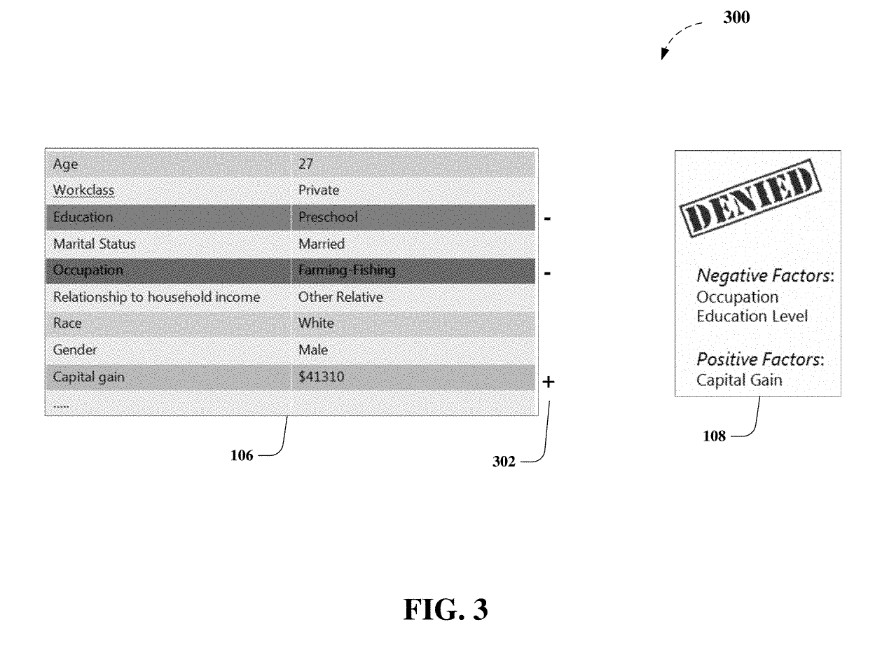

For example, FIG. 2 depicts an illustrative aspect of algorithmic transparency regarding an exemplary algorithmic decision-making system 104 (e.g., credit classifier 104) directed to credit decisions. FIG. 3 depicts another illustrative aspect of algorithmic transparency regarding an exemplary algorithmic decision-making system 104 directed to credit decisions. As seen in FIGS. 2-3, an applicant for credit may simply be denied credit with no explanation, as in FIG. 2, or with limited explanation as to why the outcome 108 of exemplary algorithmic decision-making system 104 was a denial of credit. Thus, as can be seen in FIG. 3, even with a limited explanation as to the outcome 108 of exemplary algorithmic decision-making system 104, there is no understanding or transparency as to the importance of each of the entries of data in exemplary input 106. As further described herein, various embodiments of the disclosed subject matter can include influences/explanations 112 information, such as, e.g., histograms, color-coded intensity diagrams or tabulations, etc., which is depicted in FIG. 3 as indicators 302, where “+” indicates positive factors and “−” indicates negative factors, but which could also be represented as shades of green and red (or other colors), respectively, the intensity of which could be based on the relative influence based on influences/explanations 112 information. Embodiments of the disclosed subject matter include a formal foundation to improve the transparency of such decision-making systems, including a family of Quantitative Input Influence (QII) measures that capture the degree of influence of inputs on outputs of systems. These measures can provide a foundation for various other embodiments, such as transparency reports that accompany system decisions (e.g., to explain a specific credit decision/outcome 108) and testing tools useful for internal and external oversight (e.g., to detect algorithmic discrimination or privacy violations).

For example, returning FIG. 1, various non-limiting embodiments of exemplary algorithmic transparency system 102, operatively coupled to exemplary algorithmic decision-making system 104 can employ knowledge of inputs 106, and/or other related population data, can generate exemplary intervention inputs 110, can observe resultant outcomes 108, and/or generate one or more influences/explanations 112 (e.g., one or more of one or more QII measures, transparency reports, etc.), according to various non-limiting aspects described herein.

According to one embodiment, causal QII measures can account for correlated inputs while measuring influence. QII measures support a general class of transparency queries and can explain decisions (e.g., a loan decision) about individuals and groups (e.g., disparate impact based on gender). Since single inputs may not always strongly influence the output of a decision-making system, various embodiments of the QII measures quantify the joint influence of a set of inputs (e.g., age and income) on outcomes (e.g. loan decisions) and the marginal influence of individual inputs within that set (e.g., income). Since a single input may be part of multiple influential sets of inputs, the average marginal influence of the input can be computed using principled aggregation measures, such as for example the Shapley value. Also, since transparency reports could compromise privacy, various embodiments address the transparency-privacy trade off. A number of useful transparency reports can be made differentially private with very little addition of noise.

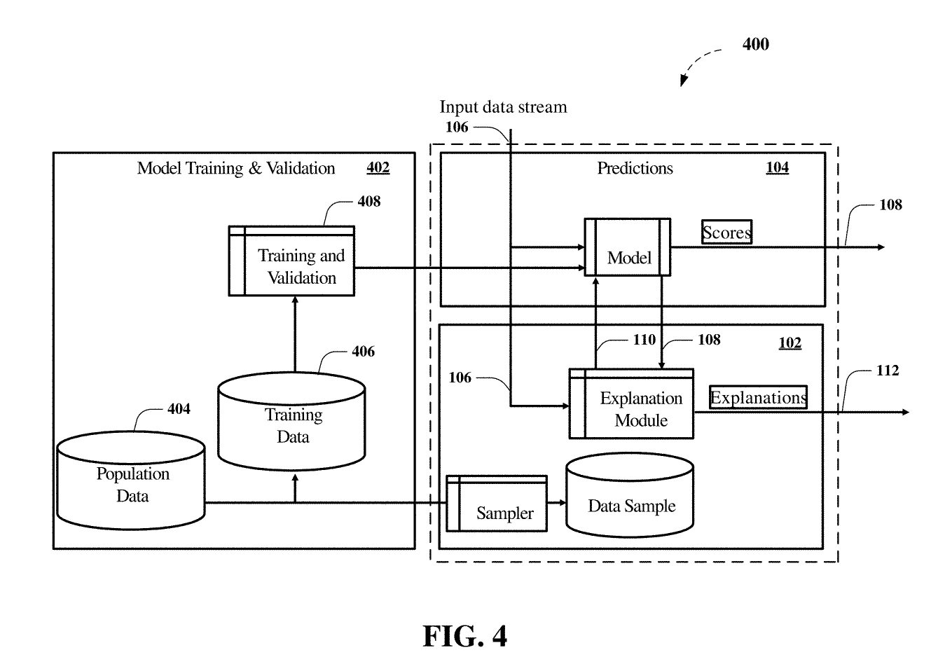

FIGS. 4-6 depict functional block diagrams illustrating exemplary architectures 400, 500, 600 according to non-limiting aspects of the disclosed subject matter. For instance, in FIG. 4, an exemplary explanation module or component of exemplary algorithmic transparency system 102 can operate on a client's infrastructure (e.g., exemplary algorithmic decision-making system 104), and it can be configured to interact with the client's model on exemplary algorithmic decision-making system 104 through an internal API (not shown) in order to provide one or more influences/explanations 112. In a further non-limiting aspect, exemplary algorithmic transparency system 102 can obtain (e.g., via an exemplary sampler or sampling component from model training and validation module 402 associated with exemplary algorithmic decision-making system 104, etc.) a sample of the population data 404 in order to create intervention inputs 110 inputs to probe client's model on exemplary algorithmic decision-making system 104. In another non-limiting aspect, an exemplary sampler or sampling component associated with exemplary algorithmic transparency system 102 can be configured to periodically sample population data 404 to provide an accurate data sample of the population data. As further shown in FIG. 4, an exemplary model on exemplary algorithmic decision-making system 104 can comprise employ or be associated with a training and validation module 408 of model training and validation module 402

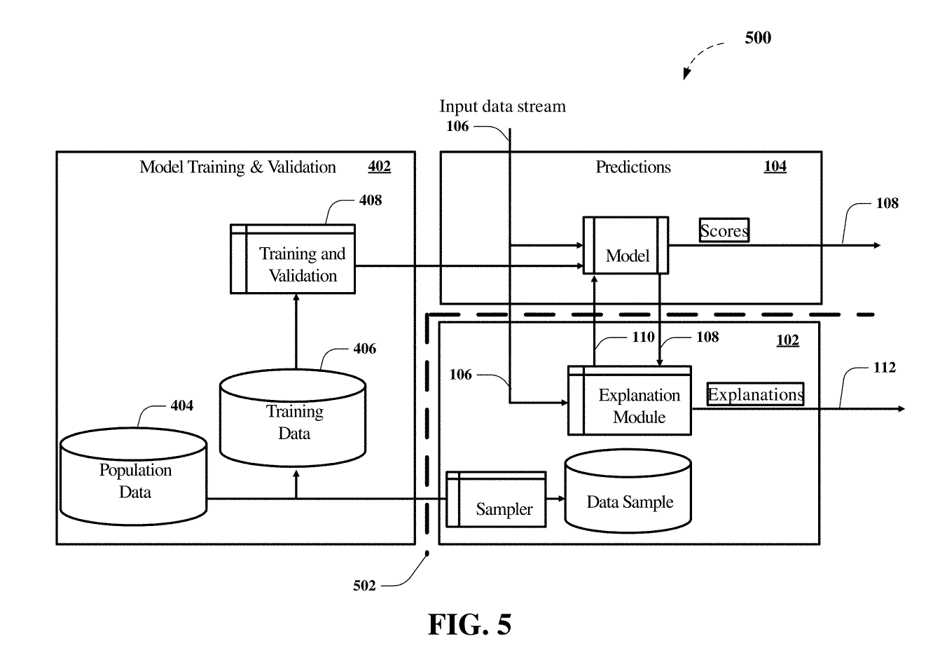

In a further non-limiting example, in FIG. 5, an exemplary explanation module or component of exemplary algorithmic transparency system 102 can operate on external infrastructure owned, operated by, or on behalf of an explanation provider (e.g., exemplary algorithmic decision-making system 104), and it can be configured to interact with the client's model on exemplary algorithmic decision-making system 104 through an external API 502 in order to provide one or more influences/explanations 112. In a further non-limiting aspect, exemplary algorithmic transparency system 102 can obtain (e.g., via an exemplary sampler or sampling component from model training and validation module 402 associated with exemplary algorithmic decision-making system 104, etc.) a sample of the population data 404 in order to create intervention inputs 110 inputs to probe client's model on exemplary algorithmic decision-making system 104. In another non-limiting aspect, an exemplary sampler or sampling component associated with exemplary algorithmic transparency system 102 can be configured to periodically sample population data 404 to provide an accurate data sample of the population data. As with FIG. 4, an exemplary model on exemplary algorithmic decision-making system 104 can comprise employ or be associated with a training and validation module 408 of model training and validation module 402.

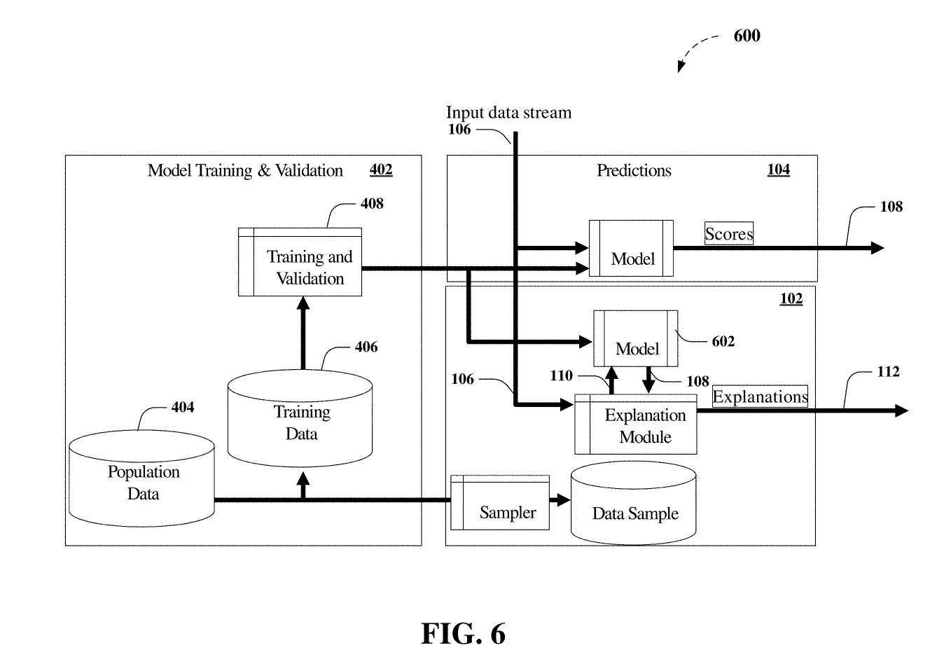

In yet another non-limiting example, in FIG. 6, an exemplary explanation module or component of exemplary algorithmic transparency system 102 can operate on external infrastructure owned, operated by, or on behalf of an explanation provider (e.g., exemplary algorithmic decision-making system 104), and it can be configured to interact with the client's model employed by exemplary algorithmic decision-making system 104 via a copy 602 of the model employed by exemplary algorithmic decision-making system 104 on the external infrastructure comprising exemplary algorithmic transparency system 102, in order to provide one or more influences/explanations 112, and/or be operatively coupled to model training and validation module 402 associated with exemplary algorithmic decision-making system 104 via an interface (not shown). In a further non-limiting aspect, exemplary algorithmic transparency system 102 can obtain (e.g., via an exemplary sampler or sampling component from model training and validation module 402 associated with exemplary algorithmic decision-making system 104, etc.) a sample of the population data 404 in order to create intervention inputs 110 inputs to probe client's model on exemplary algorithmic decision-making system 104. In another non-limiting aspect, an exemplary sampler or sampling component associated with exemplary algorithmic transparency system 102 can be configured to periodically sample population data 404 to provide an accurate data sample of the population data. As with FIGS. 4-5, an exemplary model on exemplary algorithmic decision-making system 104 can comprise employ or be associated with a training and validation module 408 of model training and validation module 402.

QII measures can be a useful transparency mechanism when black box access to a learning system is available, for example, as depicted in FIGS. 1, 4-6, etc. In particular, QII measures can provide better explanations than standard associative measures for various scenarios. Further, QII can be efficiently approximated and can be made differentially private while preserving accuracy.

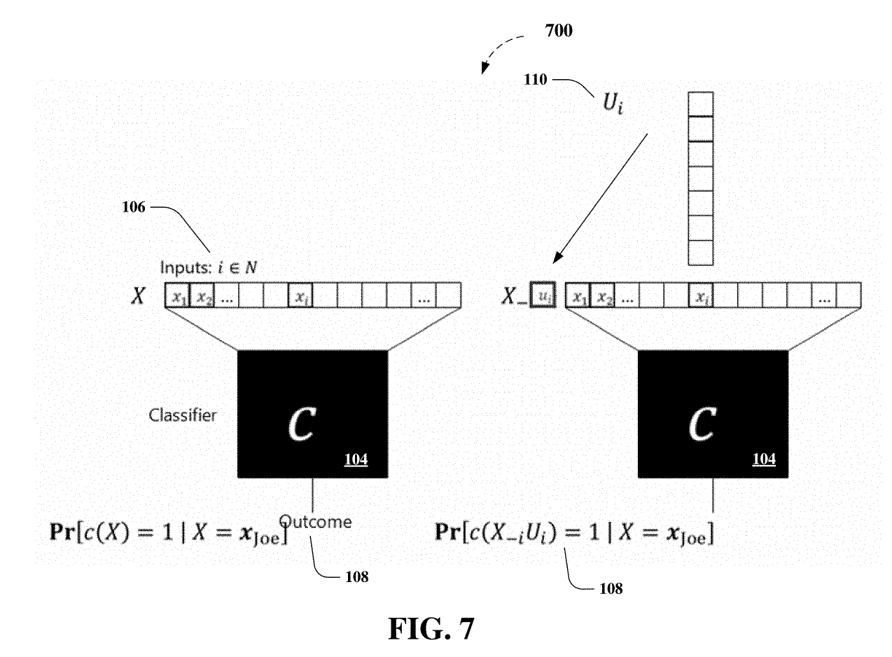

For example, FIG. 7 depicts exemplary aspects of the disclosed subject matter, in which a QII measure for individual outcomes is demonstrated, as further described herein. For instance, FIG. 7 depicts an exemplary causal intervention to exemplary algorithmic decision-making system 104, which replaces inputs 106 with random values from the population as intervention inputs 110, and examine the distribution resultant over outcomes 108 to generate one or more influences/explanations 112 (e.g., one or more of one or more QII measures, transparency reports, etc.) (not shown). In various non-limiting implementations, embodiments of the disclosed subject matter measure the influence of inputs 106 (or features) on decisions 108, about individuals or groups of individuals that are made by an algorithmic system. These measurements can be used for further uses, such as one or more influences/explanations 112 (e.g., one or more of one or more QII measures, transparency reports, etc.), which can include answers to transparency queries.

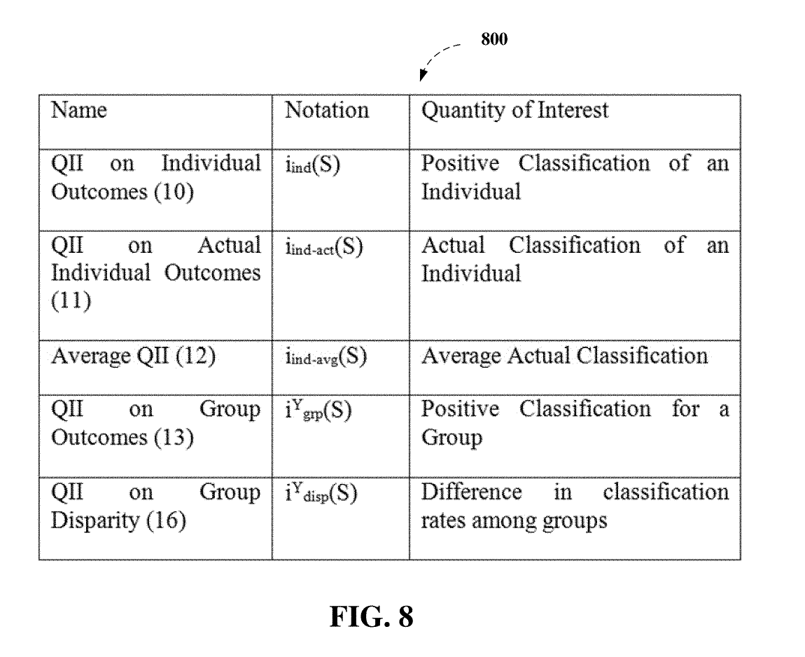

FIG. 8 tabulates a summary 800 of exemplary QII measures described herein, wherein the equation numbers listed respectively refer to the quantities of interest, as further developed below. By way of example, consider a predictive policing system that forecasts future criminal activity based on historical data; individuals identified by such a system would receive visits from the police. An individual who receives a visit from the police may seek a transparency report that provides answers to personalized transparency queries about the influence of various inputs (or features), such as the individual's race or recent criminal history, on the system's decision. Similarly, an oversight agency or the public may desire a transparency report that provides answers to aggregate transparency queries, such as the influence of certain inputs (e.g., gender, race) on the system's decisions concerning the entire population or about systematic differences in decisions among groups of individuals (e.g., discrimination based on race or age). These transparency reports can thus help identify harms and errors in input data, and provide guidance on what inputs, if changed, would modify the decision.

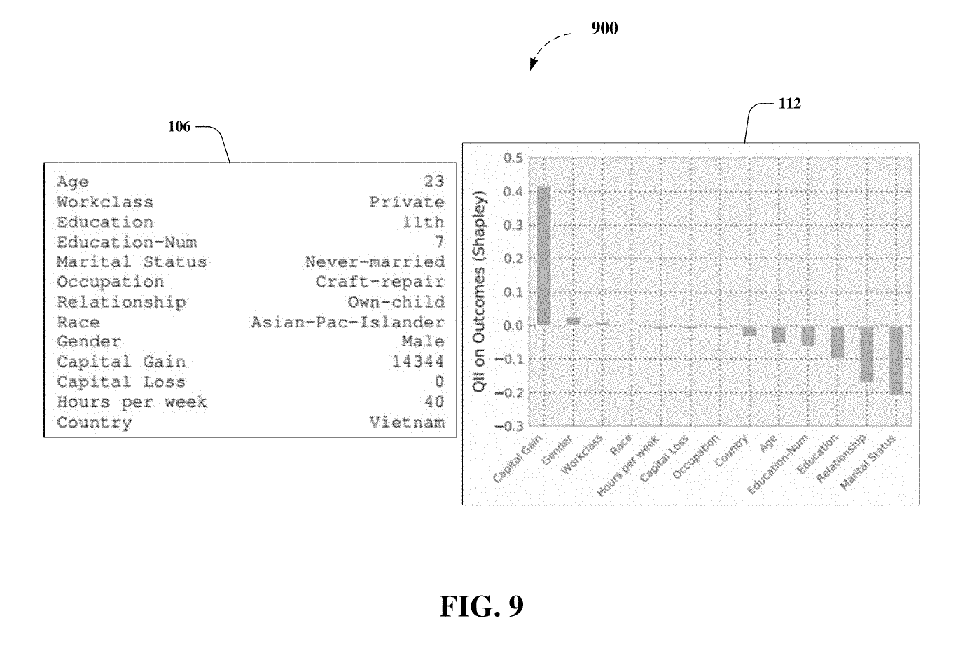

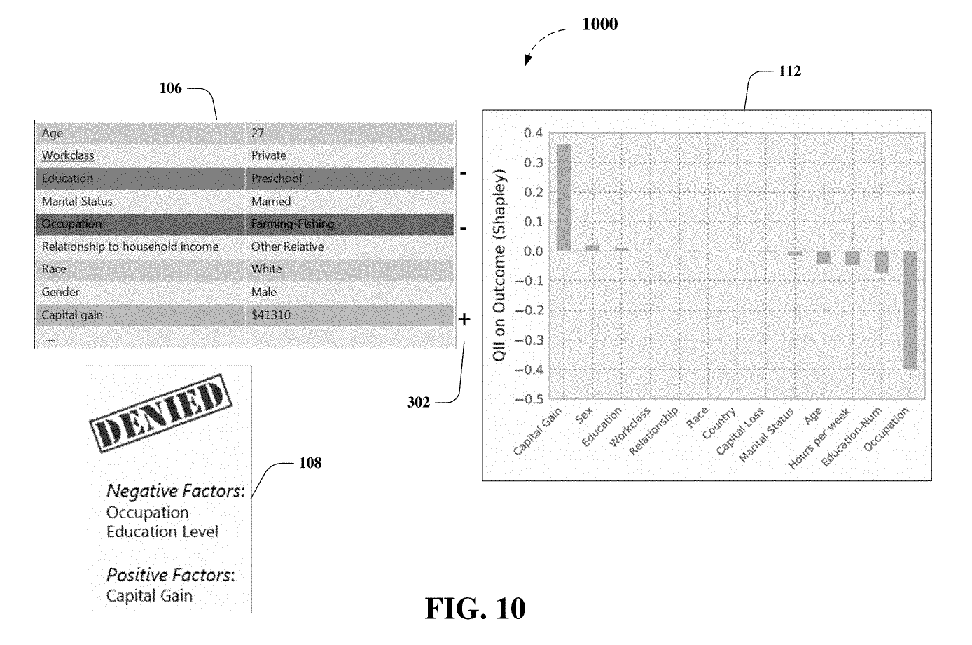

FIG. 9 depicts an exemplary histogram illustrating influences of features or inputs on outcomes, decisions, or quantities of interest associated with individuals, and FIG. 10 depicts an exemplary histogram of features or inputs on outcomes, behaviors, decisions, or quantities of interest associated with individuals, for which various aspects can be provided in an exemplary transparency report, as described herein. FIGS. 9-10 depict that while capital gain is an influential feature for approval of credit, in this exemplary credit classifier, algorithmic decision-making system 104, education level, relationship, marital status, are influential features for the denial of credit, as depicted in FIG. 9, whereas occupation and education level, are influential features for the denial of credit, as depicted in FIG. 10. The two different influences/explanations 112 (e.g., one or more of one or more QII measures, transparency reports, etc.) as depicted in FIGS. 9-10 for superficially similar people reveal that the influential features for the denial of credit can be substantially different. In addition, the two different influences/explanations 112 (e.g., one or more of one or more QII measures, transparency reports, etc.) as depicted in FIGS. 9-10 for superficially similar people assuage concerns of discrimination.

According to an embodiment, a transparency report can be generated with (a) black-box access to the decision-making system (e.g., access in which there is complete control of inputs to the decision-making system and full observability of the resulting outputs from the decision-making system) and (b) knowledge of the input data set on which the decision-making system operates, for example, as depicted in FIGS. 1, 4-6, etc. This type of access is often available to private and public sector entities that pro-actively publish transparency reports. This type of access is also a useful level of access required for internal or external oversight of such systems to identify harms introduced by them. For the former situation, transparency mechanisms can be designed. For the latter situation, decision-making systems can be tested.

Returning to the above example of predictive policing, the law enforcement agency that employs it could proactively publish transparency reports, and test the system for early detection of harms such as race-based discrimination. An oversight agency could also use transparency reports for post hoc identification of harms.

Thus, described herein are a family of Quantitative Input Influence (QII) measures that capture the degree of influence of inputs on outputs of the system. In various embodiments, these measures can facilitate some or all of the following:

First, QII measures can formalize a general class of transparency reports that enable answering many useful transparency queries related to input influence, including but not limited to the example forms described above about the system's decisions about individuals and groups.

Second, QII measures can help determine the input influence in a manner that appropriately accounts for correlated inputs, which occur in many applications. For example, consider a system that assists in hiring decisions for a moving company. Gender and the ability to lift heavy weights are inputs to the system. They are positively correlated with each other and with the hiring decisions. Yet transparency into whether the system uses the weight lifting ability or the gender in making its decisions (and to what degree) has substantive implications for determining if it is engaging in discrimination (the business necessity defense could apply in the former case). This observation makes us look beyond correlation coefficients and other associative measures.

Third, QII measures can appropriately quantify input influence in settings where any single input by itself does not have significant influence on outcomes but a set of inputs does. In such cases, it is desirable to have a measure of joint influence of a set of inputs (e.g., age and income) on a system's decision (e.g., to serve a high-paying job ad). QII measures can also help determine marginal influence of an input within such a set (e.g., age) on the decision. This provides finer-grained transparency about the relative importance of individual inputs within the set (e.g., age vs. income) in the system's decision.

It can be useful to formalize a notion of a quantity of interest. A transparency query measures the influence of an input on a quantity of interest. A quantity of interest represents a property of the behavior of the system for a given input distribution. This formalization supports a wide range of statistical properties including probabilities of various outcomes in the output distribution and probabilities of output distribution outcomes conditioned on input distribution events. Examples of quantities of interest include the conditional probability of an outcome for a particular individual or group, and the ratio of conditional probabilities for an outcome for two different groups (a metric used as evidence of disparate impact under discrimination law in the US).

Thus, it can be useful to formalize causal QII measures. These measures (also referred to herein as Unary QII) model the difference in the quantity of interest when the system operates over two related input distributions—the real distribution and a hypothetical (or counterfactual) distribution that is constructed from the real distribution in a specific way to account for correlations among inputs. Specifically, if interested in measuring the influence of an input on a quantity of interest of the system behavior, the hypothetical distribution can be constructed by retaining the marginal distribution over all other inputs and sampling the input of interest from its prior distribution. This choice breaks the correlations between this input and all other inputs, and, thus, enables measuring the influence of this input on the quantity of interest, independently of other correlated inputs.

Revisiting the moving company hiring example described above, if the decision-making system makes decisions only using the weightlifting ability of applicants, the influence of gender will be zero on the ratio of conditional probabilities of being hired for males and females. According to an embodiment, an approach to measuring the joint influence of a set of inputs can proceed in an exemplary two step process. First, a notion of joint influence of a set of inputs (called Set QII) can be defined via a generalization of the definition of the hypothetical distribution in the Unary QII definition. Second, a family of Marginal QII measures can be defined, and these marginal QII measures model the difference on the quantity of interest as sets are considered with and without the specific input whose marginal influence are desired to be measured. Depending on the application, these sets can be selected in different ways, thus providing several different measures. For example, a set of inputs could be fixed and the marginal influence determined for any given input in that set on the quantity of interest. Alternatively, the average marginal influence may be of interest for an input when it belongs to one of several different sets that significantly affect the quantity of interest.

Different forms of transparency reports may be appropriate for different settings, and accordingly QII measures can be generalized to be parametric in key elements, such as the intervention used to construct the hypothetical input distribution; the quantity of interest; the difference measure used to quantify the distance in the quantity of interest when the system operates over the real and hypothetical input distributions; and the aggregation measure used to combine marginal QII measures across different sets. This generalization can provide a structure for exploring the design space of transparency reports. Since transparency reports released to an individual, regulatory agency, or the public might compromise individual privacy, it can be useful to answer transparency queries while also protecting differential privacy.

Below is a description showing the bounds on the sensitivity of a number of transparency queries and leveraging prior results on privacy amplification via sampling to accurately answer these queries. Also described are two machine learning applications on real datasets: an income classification application based on the benchmark adult dataset, and a predictive policing application based on the National Longitudinal Survey of Youth. Using these applications, it can be empirically demonstrated that in the presence of correlated inputs, observational measures are not informative in identifying input influence. Further, transparency reports of individuals in exemplary datasets can be analyzed in order to demonstrate how Marginal QII can provide insights into individuals' classification outcomes. Finally, it is shown how, under most circumstances, QII measures can be made differentially private with minimal addition of noise, and can be approximated efficiently.

While the above details provide a general understanding and overview of various aspects related to non-limiting embodiments of the disclosed subject matter, further details regarding implementations of exemplary embodiments directed to algorithmic transparency are provided below.

For example, regarding unary QII, suppose that, in the moving company example described above, the input features used by this classification system include: Age, Gender, Weight Lifting Ability, Marital Status and Education. Suppose that, as described above, weight lifting ability is strongly correlated with gender (with men generally having better lifting ability than woman). One particular question that an analyst may want to ask is: “What is the influence of the input Gender on positive classification for women?”. The analyst observes that 20% of women are approved according to his classifier. The analyst uses a system according to an embodiment of the disclosed subject matter to replace every woman's field for gender with a random value. The system output indicates that the number of women approved does not change. In other words, an intervention on the Gender variable does not cause a significant change in the classification outcome. Repeating this process with Weight Lifting Ability results in a 20% increase in women's hiring. Therefore, system has determined that for this classifier, Weight Lifting Ability has more influence on positive classification for women than Gender. By breaking correlations between gender and weight lifting ability, the system can establish a causal relationship between the outcome of the classifier and the inputs. The system is able to identify that, despite the strong correlation between a negative classification outcome for women, the feature ‘gender’ was not a cause of this outcome.

The intuition behind such causal experimentation is formalized in the formal definition of Quantitative Input Influence (QII):

An algorithm A operates on inputs (also referred to as features), N={1, . . . , n}. Every i∈N can take on various states, given by Xᵢ. Let X=Π_{i∈N} Xᵢ be the set of possible feature state vectors, let Z be the set of possible outputs of A. For a vector x∈X and set of inputs S⊆N, X_{|S} denotes the vector of inputs in S. A probability distribution π can be defined on X, where π(x) is the probability of the input vector x. A marginal probability of a set of inputs S can be defined in the standard way as follows:

π_{S}(x_{|S})=Σ_{{x′∈X|x′|S=x|s}}π(x′) Eqn. (1)

When S is a singleton set {i}, the marginal probability of the single input can be written as πᵢ(x).

Informally, to quantify the influence of an input i, its effect can be computed on some quantity of interest; that is, the difference in the quantity of interest can be measured, when the feature i is changed via an intervention. In the example above, the quantity of interest is the fraction of positive classification of women. Herein a particular interpretation of “changing an input” can be employed, where value of every input can be replaced with a random independently chosen value. To describe the replacement operation for input i, an expanded probability space on X×X can be defined, with the following distribution:

\tilde{π}(x,u)=π(x)π(u) Eqn. (2)

The first component of an expanded vector (x; u), is just the original input vector, whereas the second component represents an independent random vector drawn from the same distribution π. Over this expanded probability space, the random variable X(x, uᵢ)=x represents the original feature vector. The random variable X₋ᵢUᵢ(x, u)=x|_{N{i}}uᵢ represents the random variable with input i replaced with a random sample. Defining this expanded probability space enables switching between the original distribution, represented by the random variable X, and the intervened distribution, represented by X₋ᵢUᵢ(x, u). Notice that both these random variables are defined from X×X, the expanded probability space, to X. The set of random variables of the type X×X→X can be denoted as R(X).

Probabilities over this expanded space can then be defined. For example, the probability over X remains the same:

$$Pr ( X = x ) = {\sum }_{\{ ( {x}^{′} , {u}^{′} ) \vert {x}^{′} = x \}} \tilde{π} ( {x}^{′} , {u}^{′} ) \\ ( {\sum }_{\{ {x}^{′} \vert {x}^{′} = x \}} π ( {x}^{′} ) ) ( {\sum }_{{u}^{′}} π ( {u}^{′} ) ) = π ( x ) \qquad Eqn . ( 3 )$$

Similarly, more complex quantities can be defined. The following expression represents the expectation of a classifier c evaluating to 1, when input i is randomly intervened on:

E(c(X₋ᵢUᵢ)=1)=Σ_{{(x,u)|c(X}_{_{N\i}}ᵤ_{ᵢ}_{)=1}}\tilde{π}(x,uᵢ) Eqn. (4)

The expression above computes the probability of the classifier c evaluating to 1, when input i is replaced with a random sample from its probability distribution πᵢ(uᵢ).

$$\begin{matrix}{\sum }_{\{ ( x , u ) \vert c ( {X}_{N \backslash i} {u}_{1} ) = 1 \}} π ( x , {u}_{i} ) = {\sum }_{x} π ( x ) {\sum }_{\{ {u}_{i}^{′} \vert c ( {X}_{N \backslash i} {u}_{i}^{′} ) = 1 \}} \\ {\sum }_{\{ u \vert {u}_{i} = {u}_{i}^{′} \}} π ( u ) \\ = {\sum }_{x} π ( x ) {\sum }_{\{ {u}_{i}^{′} \vert c ( {X}_{N \backslash i} {u}_{i}^{′} ) = 1 \}} {π}_{i} ( {u}_{i}^{′} )\end{matrix} \qquad Eqn . ( 5 )$$

Conditional distributions can also be defined in the usual way. The following represents the probability of the classifier evaluating to 1 under the randomized intervention on input I of X, given that X belongs to some subset Y⊆X:

$$E ( c ( {X}_{- i} {U}_{i} ) = 1 \vert X ∈ Y ) = \frac{E ( c ( {X}_{- i} {U}_{i} ) = 1 X ∈ Y )}{E ( X ∈ Y )} \qquad Eqn . ( 6 )$$

Formally, for an algorithm A, a quantity of interest Q_{A}(⋅): R(X)→R is a function of a random variable from R(X).

Definition 1 (QII). For a quantity of interest Q_{A}(⋅), and an input i, the Quantitative Input Influence of i on Q_{A}(⋅) can be defined to be:

i^{Q}^{_{A}}(i)=Q_{A}(X)−Q_{A}(X₋ᵢUᵢ) Eqn. (7)

In the moving company example described above, for a classifier A, the quantity of interest, the fraction of women (represented by the set W⊆X) with positive classification, can be expressed as follows:

Q_{A}(⋅)=E(A(⋅)=1|X∈W) Eqn. (8)

and the influence of input i is:

i(i)=E(A(X)=1|X∈W)−E(A(X₋ᵢUᵢ)=1|X∈W) Eqn. (9)

When A is clear from the context, Q can refer to Q_{A}. This definition can be instantiated with different quantities of interest to illustrate the above definition in three different scenarios.

A. QII for Individual Outcomes

In an embodiment, QII can be used to provide personalized transparency reports to users of data analytics systems. For example, if a person is denied a job application due to feedback from a machine learning algorithm, an explanation of which factors were most influential for that person's classification can provide valuable insight into the classification outcome.

For QII to quantify the use of an input for individual outcomes, the quantity of interest can be defined as the classification outcome for a particular individual. Given a particular individual x, Q^{x}_{ind}(⋅) can be defined to be E(c(⋅)=1|X=x). The influence measure is therefore:

i_{ind}^{x}(i)=E(c(X)=1|X=x)−E(c(X₋ᵢUᵢ)=1|X=x) Eqn. (10)

When the quantity of interest is not the probability of positive classification but is instead the classification that x actually received, a slight modification of the above QII measure can be more appropriate:

$$\begin{matrix}{i}_{ind - act}^{x} = E ( c ( X ) = c ( x ) \vert X = x ) - \\ E ( c ( {X}_{- i} {U}_{i} ) = c ( x ) \vert X = x ) \\ = 1 - E ( c ( {X}_{- i} {U}_{i} ) = c ( x ) \vert X = x ) \\ = E ( c ( {X}_{- i} {U}_{i} ) \neq c ( x ) \vert X = x )\end{matrix} \qquad Eqn . ( 11 )$$

The above probability can be interpreted as the probability that feature i is pivotal to the classification of c(x). Computing the average of this quantity over X yields:

Σ_{x∈X}Pr(X=x)E(i is pivotal for c(X)|X=x)=E(i is pivotal for c(X)) Eqn. (12)

This average QII for individual outcomes as defined above, can be denoted by i_{ind-avg}(i), and it can be used as a measure for importance of an input towards classification outcomes.

B. QII for Group Outcomes

As in the running example, the quantity of interest may be the classification outcome for a set of individuals. Given a group of individuals Y⊆X, we define Q^{Y}_{grp}(⋅) to be E(c(⋅)=1|X∈Y). The influence measure is therefore:

i^{Y}_{grp}(i)=E(c(X)=1|X∈Y)−E(c(X₋ᵢUᵢ)=1|X∈Y) Eqn. (13)

Instead of simply classification outcomes, an analyst may be interested in more nuanced properties.

C. QII for Group Disparity

Instead of simply classification outcomes, an analyst may be interested in more nuanced properties of data analytics systems. Recently, disparate impact has come to the fore as a measure of unfairness, which compares the rates of positive classification within protected groups defined by gender or race. The ‘80% rule’ in employment which states that the rate of selection within a protected demographic should be at least 80% of the rate of selection within the unprotected demographic. The quantity of interest in such a scenario is the ratio in positive classification outcomes for a protected group Y from the rest of the population X\Y.

$$\frac{E ( c ( X ) = 1 \vert \vert X ∈ Y )}{E ( c ( X ) = 1 \vert \vert X ∉ Y )} \qquad Eqn . ( 14 )$$

However, the ratio of classification rates can be unstable at low values of positive classification. Therefore, for the computations herein we use the difference in classification rates as our measure of group disparity.

Q_{disp}^{Y}(⋅)=|E(c(⋅)=1|X∈Y)−E(c(⋅)=1|X∉Y)| Eqn. (15)

The QII measure of an input group disparity, as a result is:

i_{dsp}^{Y}(i)=Q_{dsp}^{Y}(X)−Q_{dsp}^{Y}(X₋ᵢUᵢ) Eqn. (16)

More generally, group disparity can be viewed as an association between classification outcomes and membership in a group. QII on a measure of such association (e.g., group disparity) identifies the variable that causes the association in the classifier. Proxy variables are variables that can be associated with protected attributes. However, for concerns of discrimination such as digital redlining, it is important to identify which proxy variables actually introduce group disparity. It is straightforward to observe that features with high QII for group disparity are proxy variables, and also cause group disparity. Therefore, QII on group disparity is a useful diagnostic tool for determining discrimination. Note that because of such proxy variables, simply ensuring that protected attributes are not input to the classifier is not sufficient to avoid discrimination.

Set and Marginal QII

In many situations, intervention on a single input variable has no influence on the outcome of a system. Consider, for example, a two-feature setting where features are age (A) and income (I), and the classifier is c(A; I)=(A=old)∧(I=high). In other words, the only data points that are labeled 1 are those of elderly persons with high income. Now, given a data point where A=young; I=low, an intervention on either age or income would result in the same classification. However, it would be misleading to say that neither age nor income have an influence over the outcome: changing both the states of income and age would result in a change in outcome.

Equating influence with the individual ability to affect the outcome is uninformative in real datasets as well: recall that FIG. 9 depicts an exemplary histogram illustrating influences of features or inputs on outcomes, behaviors, or decisions associated with individuals. The adult dataset contains approximately 31 k data points of users' personal attributes, and whether their income is more than $50 k per annum. For most individuals, all features have zero influence. In other words, changing the state of one feature alone is not likely to change the outcome of a classifier. Of the 19537 data points, more than half have ι^{x}(i)=0 for all i∈N, Indeed, changes to outcome are more likely to occur if we intervene on sets of features. In order to get a better understanding of the influence of a feature i∈N, its effect can be measured when coupled with interventions on other features. The influence of a set of inputs can be defined as a straightforward extension of the influence of individual inputs. Essentially, the influence of a set of inputs S⊆N can be expected to be the same as when the set of inputs is considered to be a single input; when intervening on S, the states of i∈S can be drawn based on the joint distribution of the states of features in S, π_{S}(u_{S}), as defined above in Eqn. (1).

A distribution over X×Π_{i∈s}Xᵢ, can be defined naturally extending Eqn. (2) as:

\tilde{π}(x,u_{S})=π(x)π_{S}(u_{S}) Eqn. (17)

The random variable X_{-S}U_{S}(x, u_{S})=x|_{N\S}u_{S}; X_{-S}(x, u_{S}) can be defined having the states of features in N\S fixed to their original values in x, but features in S take on new values according to u_{S}.

Definition 2 (Set QII). For a quantity of interest Q, and an input i, the Quantitative Input Influence of set S⊆N on Q can be defined to be:

i^{Q}(S)=Q(X)−Q(X_{-S}U_{S}) Eqn. (18)

Considering the influence of a set of inputs opens up a number of interesting questions due to the interaction between inputs. First among these is how does one measure the individual effect of a feature, given the measured effects of interventions on sets of features. One way of doing so is by measuring the marginal effect of a feature on a set.

Definition 3 (Marginal QII). For a quantity of interest Q, and an input i, the Quantitative Input Influence of input i over a set S⊆N on Q can be defined to be:

i^{Q}(i,S)=Q(X_{-S}U_{S})−Q(X_{-S∪{i}}U_{S∪{i}}) Eqn. (19)

Notice that marginal QII can also be viewed as a difference in set QIIs: i^{Q}(S∪{i})−i^{Q}(S). Informally, the difference between i^{Q}(S∪{i})−i^{Q}(S) and i^{Q}(S) measures the “added value” obtained by intervening on S∪{i}, versus intervening on S alone.

The marginal contribution of i may vary significantly based on S. Thus, the aggregate marginal contribution of i to S can be of interest, where S is sampled from some natural distribution over subsets of N\{i}. In what follows, exemplary measures for aggregating the marginal contribution of a feature i to sets are described, based on different methods for sampling sets. In a particular non-limiting implementation, an exemplary method of aggregating the marginal contribution is the Shapley value.

A. Cooperative Games and Causality

in various non-limiting embodiments, exemplary measures from the theory of cooperative games can be employed to define measures for aggregating marginal influence. In particular non-limiting implementations, the Shapley value, characterized by axioms that are appropriate in this setting, can be employed. However, it can be understood that other measures can be appropriate for certain input data generation processes.

Definition 2 measures the influence that an intervention on a set of features S⊆N has on the outcome. One can naturally think of Set QII as a function v: 2^{N}→R, where v(S) is the influence of S on the outcome. With this intuition in mind, various embodiments can employ influence measures using cooperative game theory, and in particular, prevalent influence measures in cooperative games such as the Shapley value, Banzhaf index, and others can be employed. These measures can be thought of as influence aggregation methods, which, given an influence measure v: 2^{N}→R, output a vector φ∈Rⁿ, whose i-th coordinate corresponds in some natural way to the aggregate influence, or aggregate causal effect, of feature i.

For instance, from game-theoretic measures a revenue division context: the function v can describe the amount of money that each subset of players S⊆N can generate; assuming that the set N generates a total revenue of v(N), how should v(N) be divided amongst the players? A special case of revenue division that has received significant attention is the measurement of voting power. In voting systems with multiple agents with differing weights, voting power often does not directly correspond to the weights of the agents. For example, the U.S. presidential election can roughly be modeled as a cooperative game where each state is an agent. The weight of a state is the number of electors in that state (e.g., the number of votes it brings to the presidential candidate who wins that state). Although states like California and Texas have higher weight, swing states like Pennsylvania and Ohio tend to have higher power in determining the outcome of elections.

A voting system can be modeled as a cooperative game: players are voters, and the value of a coalition S⊆N is 1, if S can make a decision (e.g. pass a bill, form a government, or perform a task), and is 0 otherwise. Note the similarity to classification, with players being replaced by features. The game-theoretic measures of revenue division are a measure of voting power: how much influence does player i have in the decision-making process? Thus the notions of voting power and revenue division can be employed to various goals when defining aggregate QII influence measures: in both settings, one is interested in measuring the aggregate effect that a single element has, given the actions of subsets.

A revenue division should ideally satisfy certain criteria. Formally, it is desired to find a function φ(N; v), whose input is N and v: 2^{N}→R, and whose output is a vector in Rⁿ, such that φᵢ(N; v) measures some quantity describing the overall contribution of the i-th player. Research on fair revenue division in cooperative games traditionally follows an axiomatic approach: define a set of properties that a revenue division should satisfy, derive a function that outputs a value for each player, and argue that it is the unique function that satisfies these properties.

Several canonical fair cooperative solution concepts rely on the fundamental notion of marginal contribution. Given a player i and a set S⊆N\{i}, the marginal contribution of i to S can be denoted mᵢ(S; v)=v(S∪{i})−v(S) (or mᵢ(S) when v is clear from the context). Marginal QII, as defined above, can be viewed as an instance of a measure of marginal contribution. Given a permutation π∈Π(N) of the elements in N, Pᵢ(σ)={j∈N|σ(j)<σ(i)} can be defined; this is the set of i's predecessors in σ. Similarly, the marginal contribution of i to a permutation σ∈Π(N) can be defined as mᵢ(σ)=mᵢ(Pᵢ(σ)). Intuitively, one can think of the players sequentially entering a room, according to some ordering σ; the value mᵢ(σ) is the marginal contribution that i has to whoever is in the room when she enters it.

Generally speaking, game theoretic influence measures specify some reasonable way of aggregating the marginal contributions of i to sets S⊆N. That is, they measure a player's expected marginal contribution to sets sampled from some distribution D over 2^{N}, resulting in a payoff of:

E_{S˜D}[mᵢ(S)=Σ_{S⊆N}Pr_{D}[S]mᵢ(S) Eqn. (20)

Thus, fair revenue division draws its appeal from the degree to which the distribution D is justifiable within the context where revenue is shared. In some settings, the use of the Shapley value is appropriate. Introduced by the late Lloyd Shapley, the Shapley value is one of the most canonical methods of dividing revenue in cooperative games. It is defined as follows:

$${ϕ}_{i} ( N , v ) = {E}_{σ} [ {m}_{i} ( σ ) ] \frac{1}{n !} {\sum }_{σ ∈ Π ( N )} {m}_{i} ( σ ) \qquad Eqn . ( 21 )$$

Intuitively, the Shapley value describes the following process: players are sequentially selected according to some randomly chosen order σ; each player receives a payment of mᵢ(σ). The Shapley value is the expected payment to the players under this regime. The definition we use describes a distribution over permutations of N, not its subsets; however, it is easy to describe the Shapley value in terms of a distribution over subsets. If

$$p [ S ] = \frac{1}{n} \frac{1}{( \begin{matrix}n - 1 \\ \vert S \vert\end{matrix} )} ,$$

it is a simple exercise to show that:

φᵢ(N,ν)=Σ_{S⊆N}p[S]mᵢ(S) Eqn. (22)

Intuitively, p[S] describes the following process: first, choose a number k∈[0, n−1] uniformly at random; next, choose a set of size k uniformly at random.

It can be understood that a Shapley value is one of many ways of measuring influence in a non-limiting aspect. In further non-limiting aspects, the Banzhaf index, and the Deegan-Packel index can be employed, as further provided below.

B. Axiomatic Treatment of the Shapley Value

Various embodiments described herein can employ the Shapley value as one method of aggregating marginal feature influence. What follows is a brief exposition of axiomatic game-theoretic value theory. Axioms that define the Shapley value are presented in how they apply in the QII setting are discussed. As described herein, by requiring some desired properties, one arrives at a game-theoretic influence measure as the unique function for measuring information use in certain settings. The Shapley value satisfies the following properties:

Definition 4 (Symmetry (Sym)). It can be defined that i, j∈N are symmetric if v(S∪{i})=v(S∪{j}) for all S⊆N\{i, j}. A value φ satisfies symmetry if φᵢ=φⱼ, whenever i and j are symmetric.

Definition 5 (Dummy (Dum)). A player i∈N is a dummy if v(S∪{i})=v(S) for all S⊆N. A value ϕ satisfies the dummy property if φᵢ=0 whenever i is a dummy.

Definition 6 (Efficiency (Eff)). A value satisfies the efficiency property if Σ_{i∈N}φᵢ=ν(N).

These axioms can be employed, or an interpretation can be employed, in the QII setting. Indeed, if two features have the same probabilistic effect, no matter what other interventions are already in place, they should have the same influence. In the present context, the dummy axiom says that a feature that never offers information with respect to an outcome should have no influence. In the case of specific causal influence, the efficiency axiom simply states that the total amount of influence should sum to:

$$Pr ( c ( C ) = c ( x ) \vert X = x ) - Pr ( c ( {X}_{- N} ) = c ( x ) \vert X = x ) = 1 - Pr ( c ( X ) = c ( X ) ) = Pr ( c ( X ) ∉ c ( X ) ) \qquad Eqn . ( 23 )$$

That is, the total amount of influence possible is the likelihood of encountering elements whose evaluation is not c(x). If the vast majority of elements have a value of c(x), it is quite unlikely that changes in features' state will have any effect on the outcome whatsoever; thus, the total amount of influence that can be assigned is Pr(c(X)≠c(x)). Similarly, if the vast majority of points have a value different from x, then it is likelier that a random intervention would result in a change in value, resulting in more influence to be assigned.

It can be shown that the Shapley value is the only function that satisfies (Sym), (Dum), (Eff), as well as the additivity (Add) axiom.

Definition 7 (Additivity (Add)). Given two games [symbol] N, ν₁ [symbol] , [symbol] N, ν₂ [symbol] , [symbol] N, ν₁+ν₂ [symbol] Can be written to denote the game v′(S)=v₁(S)+v₂(S) for all S⊆N. A value ϕ satisfies the additivity property if φᵢ(N, v₁)+φᵢ(N, v₂)=φᵢ(N, v₁+v₂) for all i∈N.

In the present context, the additivity axiom makes little intuitive sense; it would imply, for example, that if Q were multiplied by a constant c, the influence of i in the resulting game should be multiplied by c as well, which is difficult to justify. Thus, an alternative characterization of the Shapley value, based on the more natural monotonicity assumption, which is a strong generalization of the dummy axiom, can be employed.

Definition 8 (Monotonicity (Mono)). Given two games [symbol] N, ν₁ [symbol] , [symbol] N, ν₂ [symbol] , a value φ satisfies strong monotonicity if mᵢ(S, v₁)≥mᵢ(S, v₂) for all S implies that φᵢ(N, v₁)≥ϕᵢ(N, v₂), where a strict inequality for some set S⊆N implies a strict inequality for the values as well.

Thus, in further non-limiting aspects, a monotonicity assumption is appropriate in the QII setting: if a feature has consistently higher influence on the outcome in one setting than another, its measure of influence should increase. For example, if a user receives two transparency reports (say, for two separate loan applications), and in one report gender had a consistently higher effect on the outcome than in the other, then the transparency report should reflect this.

Theorem 9. The Shapley value is the only function that satisfies (Sym), (Eff) and (Mono).

Accordingly, in various non-limiting implementations, the Shapley value can be employed as a method of measuring aggregate influence in the QII setting, while also satisfying a set of very natural axioms.

Transparency Schemas

The disclosed subject matter further describes two generalizations of the definitions presented above, and then define a transparency schema that map the space of transparency reports based on QII.

a) Intervention Distribution: In an embodiment, there are randomized interventions when the interventions are drawn independently from the priors of the given input. However, in other embodiments different interventions can be employed. Formally, this is achieved by allowing an arbitrary intervention distribution π^{inter} such that:

\tilde{π}(x,u)=π(x)π^{inter}(u) Eqn. (24)

The subsequent definitions can remain unchanged. One example of an intervention different from the randomized intervention described in various embodiments is one held constant at a vector x₀:

$${π}_{{x}_{0}}^{inter} ( u ) = \{ \begin{matrix}1 & for u = {x}_{0} \\ 0 & otherwise\end{matrix} \qquad Eqn . ( 25 )$$

A QII measure defined on the constant intervention, as defined above, can measure the influence of being different from a default, where the default is represented by x₀.

b) Difference Measure: A second generalization allows the consideration of quantities of interest which are not real numbers. Consider, for example, the situation where the quantity of interest is an output probability distribution, as in the case in a randomized classifier. In this setting, a suitable measure for quantifying the distance between distributions can be used as a difference measure between the two quantities of interest. Examples of such difference measures include the Kullback-Leibler divergence between distribution or distance metrics between vectors.

c) Transparency Schema: According to further non-limiting aspects, a transparency schema that maps the space of transparency reports based on QII measures can be employed, which can consist of the following elements:

A quantity of interest, which captures the aspect of the system for which transparency is desired.

An intervention distribution, which defines how a counterfactual distribution is constructed from the true distribution.

A difference measure, which quantifies the difference between two quantities of interest.

An aggregation technique, which combines marginal QII measures across different subsets of inputs (features).

For a given application, one has to appropriately instantiate this schema. Several instances of each schema element are described herein, in further non-limiting aspects. The choices of the schema elements can be guided by the particular causal question being posed. For instance, when the question is: “Which features are most important for group disparity?”, the natural quantity of interest is a measure of group disparity, and the natural intervention distribution is using the prior as the question does not suggest a particular bias. On the other hand, when the question is: “Which features are most influential for person A's classification as opposed to person B?”, a natural quantity of interest is person A's classification, and a natural intervention distribution is the constant intervention using the features of person B.

Estimation

A. Computing Power Indices

Computing the Shapley or Banzhaf values exactly is generally computationally intractable; however, their probabilistic nature means that they can be well-approximated via random sampling. More formally, given a random variable X, suppose that estimating some determined quantity q(X) (say, q(X) is the mean of X) is desired; a random variable q* can be stated as an ε-δ approximation of q(X) if:

Pr[|q*−−q(X)|≥ε]<δ Eqn. (26)

In other words, it is extremely likely that the difference between q(X) and q* is no more than ε. An ε-δ approximation scheme for q(X) is an algorithm that for any ε, δ∈ (0, 1) is able to output a random variable q* that is an ε-δ approximation of q(X), and runs in time polynomial in

$$\frac{1}{∈}$$

and polynomial in log

$$\frac{1}{δ} .$$

It can be understood that when [symbol] N|ν [symbol] is a simple game (e.g., a game where v(S)∈{0, 1} for all S⊆N), there exists an ε-δ approximation scheme for both the Banzhaf and Shapley values; that is, for φ∈{φ,β}, we can guarantee that for any ε, δ>0, with probability ≥1−δ, we output a value φ*ᵢ such that |φ*ᵢ−φᵢ|<ε.

More generally, it can be observed that the number of independent, identically distributed samples needed in order to approximate the Shapley value and Banzhaf index is parameterized in Δ(v)=max_{S⊆N} v(S)−min_{S⊆N} v(S). Thus, if Δ(v) is a bounded value, then an ε-δ approximation exists. In the present context, coalitional values are always within the interval [0, 1], which immediately implies the following theorem.

Theorem 10. There exists an ε-δ approximation scheme for the Banzhaf and Shapley values in the QII setting.

B. Estimating Q

Without access to the prior generating the data, it can be estimated by observing the dataset itself. Recall that X is the set of all possible user profiles; in this case, a dataset is simply a multiset (e.g., possibly containing multiple copies of user profiles) contained in X. Let D be a finite multiset of X, the input space. The probabilities can be estimated by computing sums over D. For example, for a classifier c, the probability of c(X)=1.

$$( c ( X ) = 1 ) = \frac{{\sum }_{x ∈ D}^{ } 1 ( c ( x ) = 1 )}{\vert D \vert} \qquad Eqn . ( 27 )$$

Given a set of features S⊆N, let D_{|S} denote the elements of D truncated to only the features in S. Then, the intervened probability can be estimated as follows:

$$( c ( {X}_{- S} ) = 1 ) = \frac{{\sum }_{{u}_{S} ∈ {D}_{\vert S}}^{ } {\sum }_{x ∈ D}^{ } 1 ( c ( {x}_{\vert N \backslash S} {u}_{S} ) = 1 )}{{\vert D \vert}^{2}} \qquad Eqn . ( 28 )$$

Similarly, the intervened probability on individual outcomes can be estimated as follows:

$$( c ( {X}_{- S} ) = 1 \vert X = x ) = \frac{{\sum }_{{u}_{S} ∈ {D}_{\vert S}}^{ } 1 ( c ( {x}_{\vert N \backslash S} {u}_{S} ) = 1 )}{\vert D \vert} \qquad Eqn . ( 29 )$$

Finally, group disparity can be observed as:

| [symbol] (c(X_{-S})=1|X∈Y)− [symbol] (c(X_{-S})=1|X∉Y)| Eqn. (30)

The term [symbol] (c(X_{-S})=1|X∈Y) equals:

$$\frac{1}{\vert Y \vert} {\sum }_{u ∈ Y}^{ } {\sum }_{{u}_{S} ∈ {D}_{S}}^{ } 1 ( c ( {x}_{\vert N \backslash S} {u}_{S} ) = 1 ) \qquad Eqn . ( 31 )$$

Thus group disparity can be written as:

$$\vert \frac{1}{\vert Y \vert} {\sum }_{u ∈ Y}^{ } {\sum }_{{u}_{S} ∈ {D}_{S}}^{ } 1 ( c ( {x}_{\vert N \backslash S} {u}_{S} ) = 1 ) - \frac{1}{\vert D \backslash Y \vert} {\sum }_{x ∈ D \backslash Y}^{ } {\sum }_{{u}_{S} ∈ {D}_{S}}^{ } 1 ( c ( {x}_{\vert N \backslash S} {u}_{S} ) = 1 ) \vert \qquad Eqn . ( 32 )$$

\hat{Q}_{disp}^{Y}(S) is used herein denote Eqn. (32).

If D is large, these sums cannot be computed efficiently. Therefore, the sums can be approximated by sampling from the data set D. It is possible to show using the Hoeffding bound, partial sums of n random variables Xᵢ, within a bound Δ, can be well-approximated with the following probabilistic bound:

$$Pr ( \vert \frac{1}{n} {\sum }_{i = 1}^{n} ( {X}_{i} - {EX}_{i} ) \vert \geq ϵ ) \leq 2 exp ( \frac{- 2 n {ɛ}^{2}}{Δ} ) \qquad Eqn . ( 33 )$$

Since all the samples of measures discussed herein are bounded within the interval [0,1], an ε-δ approximation scheme can be admitted where the number of samples n can be chosen to be greater than log(2/δ)/2ε². Note that these bounds are independent of the size of the data set. Therefore, given an efficient sampler, these quantities of interest can be approximated efficiently even for large datasets.

Private Transparency Reports

One important concern is that releasing influence measures estimated from a data set might leak information about individual users. In various embodiments, accurate transparency reports can be provided, which transparency reports do not compromise individual users' private data. To mitigate the concern of leaked information, noise can be added to make the measures differentially private. For instance, in a further non-limiting aspect, the sensitivities of the QII measures considered herein are very low, and therefore, very little noise needs to be added to achieve differential privacy.

The sensitivity of a function is a key parameter in ensuring that it is differentially private; it is simply the worst-case change in its value, assuming that a single data point in the dataset is changed. Given some function f over datasets, sensitivity of a function f can be defined with respect to a dataset D, denoted by Δf(D) as:

$${}_{{D}^{′}}^{ma x} \vert f ( D ) - f ( {D}^{′} ) \vert \qquad Eqn . ( 34 )$$

where D and D′ differ by at most one instance. Shorthand Δf is employed herein when D is clear from the context.

In order to not leak information about the users used to compute the influence of an input, a Laplace Mechanism can be employed to make the influence measure differentially private. The amount of noise required depends on the sensitivity of the influence measure. The influence measure has low sensitivity for the individuals used to sample inputs, in a further non-limiting aspect. Further, it can be understood that sampling amplifies the privacy of the computed statistic, allowing various embodiments described herein to achieve high privacy with minimal noise addition.

Accordingly, various embodiments can employ a technique for making any function differentially private, for example, by adding Laplace noise calibrated to the sensitivity of the function.

Theorem 11. For any function f from datasets to R, the mechanism K_{f} that adds independently generated noise with distribution Lap(Δf(D)/ε) to the k output enjoys ε-differential privacy.

Since each of the quantities of interest aggregate over a large number of instances, the sensitivity of each function is very low.

Theorem 12. Given a dataset D,

$$1 ) Δ {\hat{E}}_{D} ( c ( X ) = 1 ) = \frac{1}{\vert D \vert} \\ 2 ) Δ {\hat{E}}_{D} ( c ( {X}_{- S} ) = 1 ) \leq \frac{2}{\vert D \vert} \\ 3 ) Δ {\hat{E}}_{D} ( c ( {X}_{- S} ) = 1 \vert X = x ) = \frac{1}{\vert D \vert} \\ 4 ) {\hat{Q}}_{disp}^{Y} ( S ) \leq max \{ \frac{1}{\vert D ⋂ Y \vert} , \frac{1}{\vert D \backslash Y \vert} \}$$

Proof. In Eqn. (27), if two datasets differ by one instance, then at most one term of the summation will differ. Since each term can only be either 0 or 1, the sensitivity of the function is:

$$Δ {\hat{E}}_{D} ( c ( X ) = 1 ) = \vert \frac{0}{\vert D \vert} - \frac{1}{\vert D \vert} \vert = \frac{1}{\vert D \vert} \qquad Eqn . ( 35 )$$

Similarly, in Eqn. (28), an instance appears 2|D|−1 times, once each for the inner summation and the outer summation, and therefore, the sensitivity of the function is:

$$Δ {\hat{E}}_{D} ( c ( {X}_{- S} ) = 1 ) = \frac{2 \vert D \vert - 1}{{\vert D \vert}^{2}} \leq \frac{2}{\vert D \vert} \qquad Eqn . ( 36 )$$

For individual outcomes (Eqn. (29)), similarly, only one term of the summation can differ. Therefore, the sensitivity of (29) is 1/|D|.

Finally, it can be observed that a change in a single element x′ of D will cause a change of at most

$$\frac{1}{\vert D ⋂ Y \vert}$$

if x′∈D∩Y, or at most

$$\frac{1}{\vert D \backslash Y \vert}$$

if x′∈D\Y. Thus, the maximal change to Eqn. (32) is at most max

$$\{ \frac{1}{\vert Y \vert} , \frac{1}{\vert D \backslash Y \vert} \} .$$

While the sensitivity of most quantities of interest is low (at most

$$\frac{2}{\vert D \vert} ) , {\hat{Q}}_{disp}^{Y} ( S )$$

can be quite high when |Y| is either very small or very large. This makes intuitive sense: if Y is a very small minority, then any changes to its members are easily detected; similarly, if Y is a vast majority, then changes to protected minorities may be easily detected.

It can be observed that the quantities of interest that exhibit low sensitivity will have low influence sensitivity as well: for example, the local influence of S is 1(c(x)=1)−Ê_{D}(c(X_{-S})=1|X=x); changing any x′∈D (where x′≠x will result in a change of at most

$$\frac{1}{\vert D \vert}$$

to the local influence.

Finally, since the Shapley and Banzhaf indices are normalized sums of the differences of the set influence functions, it can be shown that if an influence function i has sensitivity Δi, then the sensitivity of the indices is at most 2Δi.

The QII measures discussed above (except for group parity) have a sensitivity of

$$\frac{α}{\vert D \vert} ,$$

with α being a small constant. To ensure differential privacy, noise can be added, in further non-limiting aspects, with a Laplacian distribution Lap(k/|D|) to achieve 1-differential privacy. Further, sampling can be employed to amplify differential privacy.

Theorem 13. If A is 1-differentially private, then for any ε∈(0, 1), A′(ε) is 2ε-differentially private, where A′(ε) is obtained by sampling an ε fraction of inputs and then running A on the sample. Therefore, various embodiments of the disclosed subject matter of sampling instances from D to speed up computation has the additional benefit of ensuring that the disclosed computation is private.

FIG. 8 tabulates a summary 800 of exemplary QII measures described herein, wherein the equation numbers listed respectively refer to the quantities of interest, as further developed above.

A. Probabilistic Interpretation of Power Indices

In order to quantitatively measure the influence of data inputs on classification outcomes, causal interventions on sets of features are proposed; as described herein, the aggregate marginal influence of i for different subsets of features is a natural quantity representing its influence. In order to aggregate the various influences i has on the outcome, some probability distribution over (or equivalently, a weighted sum of) subsets of N\{i} can be defined, where Pr[S] represents the probability of measuring the marginal contribution of i to S; Pr[S] yields a value Σ_{S⊆N\{i}}mᵢ(s).

For the Banzhaf index, we have

$$Pr [ S ] = \frac{1}{{2}^{n - 1}} ,$$

the Shapley value has

$$Pr [ S ] = \frac{k ! ( n - k - 1 ) !}{n !}$$

(here, |S|=k), and the Deegan-Packel Index selects minimal winning coalitions uniformly at random. These choices of values for Pr[S] are based on some natural assumptions on the way that players (features) interact, but they are by no means exhaustive. Other sampling methods can be defined as desired for the model at hand; for example, it is entirely possible that the only interventions that are possible in a certain setting are of size ≤k+1, it is reasonable to aggregate the marginal influence of i over sets of size ≤k, i.e.

$$Pr [ S ] = \{ \begin{matrix}\frac{1}{( \begin{matrix}n - 1 \\ \vert S \vert\end{matrix} )} & if \vert S \vert \leq k \\ 0 & otherwise\end{matrix} \qquad Eqn . ( 37 )$$

Some aggregation method should be defined, and that choice reflects some normative approach on how (and which) marginal contributions are considered, in further non-limiting aspects. While Shapley and Banzhaf indices do have some highly desirable properties, but they are, first and foremost, a-priori measures of influence. That is, they do not factor in any assumptions on what interventions are possible or desirable.

One natural candidate for a probability distribution over S is some natural extension of the prior distribution over the dataset; for example, if all features are binary, one can identify a set with a feature vector (namely by identifying each S⊆N with its indicator vector), and set Pr[S]=π(S) for all S⊆N.

If features are not binary, then there is no canonical way to transition from the data prior to a prior over subsets of features.

B. Fairness

Due to the widespread and black box use of machine learning in aiding decision-making, there is a legitimate concern of algorithms introducing and perpetuating social harms such as racial discrimination. As a result, the algorithmic foundations of fairness in personal information processing systems have received significant attention recently. While many of the algorithmic approaches have focused on group parity as a metric for achieving fairness in classification, others argue that group parity is insufficient as a basis for fairness, and propose a similarity-based approach which prescribes that similar individuals should receive similar classification outcomes. However, this approach requires a similarity metric for individuals, which is often subjective and difficult to construct.

QII does not suggest any normative definition of fairness. Instead, QII can be viewed as a diagnostic tool to aid fine-grained fairness determinations. In fact, QII can be used in the spirit of a similarity based definition, for example, by comparing the personalized privacy reports of individuals, who are perceived to be similar, but received different classification outcomes, and identifying the inputs which were used by the classifier to provide different outcomes. Additionally, when group parity is used as a criterion for fairness, QII can identify the features that lead to group disparity, thereby identifying features being used by a classifier as a proxy for sensitive attributes.

The determination of whether using certain proxies for sensitive attributes is discriminatory is often a task-specific normative judgment. For example, using standardized test scores (e.g., SAT scores) for admissions decisions is by and large accepted, although SAT scores may be a proxy for several protected attributes. In fact, several universities have recently announced that they will not use SAT scores for admissions citing this reason. Embodiments of the disclosed subject matter can be used to provide fine-grained transparency into input usage (e.g., the extent to which SAT scores influence decisions), which can be useful to make determinations of discrimination from a chosen normative position.

Moreover, whether providing a sensitive attribute as an input to a classifier is fundamentally discriminatory behavior, can be examined to a positive outcome, if QII can show that the sensitive input has no significant impact on the outcome. From the standpoint of information use, two situations can be treated as identical: the sensitive input is not really used although it is supplied; the very fact that it was supplied might be indicative of an intent to discriminate, even if that intended goal was not achieved. Regardless, QII remains a useful diagnostic tool for studying discrimination of algorithmic decision-making systems, because of the presence of proxy variables as described herein.

Alternative Game-Theoretic Influence Measures

In addition to the exemplary influence measures described above, below are descriptions of two alternatives to the Shapley value. While the Shapley value is appropriate to use in some settings, other measures might be appropriate for certain input data generation processes. As non-limiting examples, the Banzhaf index and the Deegan-Packel index, a game-theoretic influence measure with deep connections to a formal theory of responsibility and/or blame, can be suitable.

A. The Banzhaf Index

Recall that the Banzhaf index, denoted βᵢ(N; v) can be defined as follows:

$${β}_{i} ( N , v ) = \frac{1}{{2}^{n - 1}} {\sum }_{S ⊆ N \{ i \}} {m}_{i} ( S ) \qquad Eqn . ( 38 )$$

The Banzhaf index can be thought of as follows: each j∈N\{i} will join a work effort with probability ½ (or, equivalently, each S⊆N\{i} has an equal chance of forming); if i joins as well, then its expected marginal contribution to the set formed is exactly the Banzhaf index. Note the marked difference between the probabilistic models: under the Shapley value, sample permutations are performed uniformly at random, whereas under the regime of the Banzhaf index, sets are sampled uniformly at random. The different sampling protocols reflect different normative assumptions, in a further non-limiting aspect. For one, the Banzhaf index is not guaranteed to be efficient; that is, Σ_{i∈N}βᵢ(N, ν) is not necessarily equal to v(N), whereas it is always the case that Σᵢ₌₁ⁿφᵢ(N, ν)=v(N). Moreover, the Banzhaf index is more biased towards measuring the marginal contribution of i to sets of size

$$\frac{n}{2} \pm O ( \sqrt{n} ) ;$$

this is because the expected size of a randomly selected set follows a binomial distribution

$$B ( n , \frac{1}{2} ) .$$

On the other hand, the Shapley value is equally likely to measure the marginal contribution of i to sets of any size k∈{0, . . . , k}, as i is equally likely to be in any one position in a randomly selected permutation σ (and, in particular, the set of i's predecessors in σ is equally likely to have any size k∈{0, . . . , n−1}.

In the QII context, the difference in sampling procedure is not merely an interesting anecdote: it is a significant modeling choice. Intuitively, the Banzhaf index can be more appropriate if it can be assumed that large sets of features would have a significant influence on outcomes, whereas the Shapley value can be more appropriate if it can be assumed that even small sets of features might cause significant effects on the outcome. Indeed, as described herein, aggregating the marginal influence of i over sets is a significant modeling choice. Using the measures explicitly described herein is perfectly reasonable in many settings. In various embodiments of the disclosed subject matter, other aggregation methods can be used in the same settings described herein or in different settings.

Unlike the Shapley value, the Banzhaf index is not guaranteed to be efficient (although it does satisfy the symmetry and dummy properties). Indeed, it can be shown that replacing the efficiency axiom with an alternative axiom, uniquely characterizes the Banzhaf index; the axiom, called 2-efficiency, prescribes the behavior of an influence measure when two players merge. First, a merged game can be defined; given a game [symbol] N|ν [symbol] , and two players i, j∈N, then T={i, j}. The game ν̅ on N\T∪{t} can be defined as follows: for every set S⊆N\{i, j}, ν̅(S)=v(S), and ν̅(S∪{t})=v(S∪{i,j}), note that the added player t̅ represents the two players i and j who are now acting as one. The 2-Efficiency axiom states that influence should be invariant under merges.

Definition 14 (2-Efficiency (2-EFF)). Given two players i, j∈N, let ν̅ be the game resulting from the merge of i and j into a single player t̅; an influence measure φ satisfies 2-Efficiency if φᵢ(N, v)+φⱼ(N, v)=φ_{t̅}(N\{i, j}∪{t̅}, ν̅).

Theorem 15. The Banzhaf index is the only function to satisfy (Sym), (D), (Mono) and (2-EFF).

In the present context, 2-Efficiency can be interpreted as follows: supposing that two features i and j can be artificially treated as one, keeping all other parameters fixed; in this setting, 2-efficiency means that the influence of merged features equals the influence they had as separate entities.

B. The Deegan-Packel Index

In further non-limiting aspects, the Deegan-Packel index can be employed. While the Shapley value and Banzhaf index are well-defined for any coalitional game, the Deegan-Packel index is only defined for simple games. A cooperative game is said to be simple if v(S)∈{0, 1} for all S⊆N. In the present context, an influence measure would correspond to a simple game if it is binary (e.g., it measures some threshold behavior, or corresponds to a binary classifier). The binary requirement is rather strong; however, the Deegan-Packel index has an interesting connection to causal responsibility, a variant of the classic Pearl-Halpern causality model, which aims to measure the degree to which a single variable causes an outcome.

Given a simple game v:2^{N}→{0,1}, let M(v) be the set of minimal winning coalitions; that is, for every S∈M(v), v(S)=1, and v(T)=0 for every strict subset of S. The Deegan-Packel index assigns a value of:

$${δ}_{i} ( N , v ) = \frac{1}{\vert M ( v ) \vert} {\sum }_{S ∈ M ( v ) : i ∈ S} \frac{1}{\vert S \vert} \qquad Eqn . ( 39 )$$

The intuition behind the Deegan-Packel index is as follows: players will not form coalitions any larger than what they absolutely have to in order to win, so it does not make sense to measure their effect on non-minimal winning coalitions. Furthermore, when a minimal winning coalition is formed, the benefits from its formation are divided equally among its members; in particular, small coalitions confer a greater benefit for those forming them than large ones. The Deegan-Packel index measures the expected payment one receives, assuming that every minimal winning coalition is equally likely to form. Interestingly, the Deegan-Packel index corresponds nicely to the notion of responsibility and/or blame.

Suppose a set of variables X₁, . . . , Xₙ set to x₁, . . . , xₙ, and some binary effect f(x₁, . . . , xₙ) (written as f(x)) occurs (say, f(x)=1). To establish a causal relation between the setting of Xᵢ to xᵢ and f(x)=1, it can be required that there is some set S⊆N\{i} and some values (yⱼ)_{j∈S∪{i}} such that f(x_{-S∪{i}}, (yⱼ)_{j∈S∪{i}}=0, but f(x_{-S}, (yⱼ)_{j∈S})=1. In other words, an intervention on the values of both S and i may cause a change in the value of f, but performing the same intervention just on the variables in S would not cause such a change. This definition is at the heart of the marginal contribution approach to interventions described herein. Thus, it can be defined that the responsibility of i for an outcome as

$$\frac{1}{k + 1} ,$$

where k is the size of the smallest set S for which the causality definition holds with respect to i. The Deegan-Packel index can thus be thought of as measuring a similar notion: instead of taking the overall minimal number of changes necessary in order to make i a direct, counterfactual cause, all minimal sets can be observed that do so. Taking the average responsibility of i (or blame) according to this variant, obtain the Deegan-Packel index can be obtained.

For example, consider the following setup. There are n=2k+1 voters (n is an odd number) who must choose between two candidates, Mr. B and Mr. G ([41] describe the setting with n=11). All voters elected Mr. B, resulting in an n-0 win. It is natural to ask: how responsible was voter i for the victory of Mr. B? Accordingly, it can be understood that the degree of responsibility of each voter can be shown to be

$$\frac{1}{k + 1} .$$

It will require that i and k additional voters change their vote in order for the outcome to change. Modeling this setup as a cooperative game is quite natural: the voters are the players N={1, . . . , n}; for every subset S⊆N we have:

$$v ( S ) = \{ \begin{matrix}1 & if \vert S \vert \geq k + 1 \\ 0 & otherwise\end{matrix} \qquad Eqn . ( 40 )$$

That is, v(S)=1 if and only if the set S can change the outcome of the election. The minimal winning coalitions here are the subsets of N of size k+1, thus the Deegan-Packel index of player i is:

$$\begin{matrix}{δ}_{i} ( N , v ) = \frac{1}{\vert M ( v ) \vert} {\sum }_{S ∈ M ( v ) : i ∈ S} \frac{1}{\vert S \vert} \\ = \frac{1}{( \begin{matrix}n \\ k + 1\end{matrix} )} ( \begin{matrix}n \\ k\end{matrix} ) \frac{1}{k + 1} = \frac{1}{n - k} = \frac{1}{k + 1}\end{matrix} \qquad Eqn . ( 41 )$$

Note that if one assumes that all voters are equally likely to prefer Mr. B over Mr. G, then the blame of voter i would be computed in the exact manner as the Deegan-Packel index.

While various non-limiting implementation systems and methods for algorithmic transparency have been described above in order to provide an understanding of exemplary aspects of the specification, various non-limiting devices, systems, and methods are now described as a further aid in understanding the advantages and benefits of various embodiments of the disclosed subject matter. To that end, it can be understood that such descriptions are provided merely for illustration and not limitation.

### Exemplary Systems and Devices

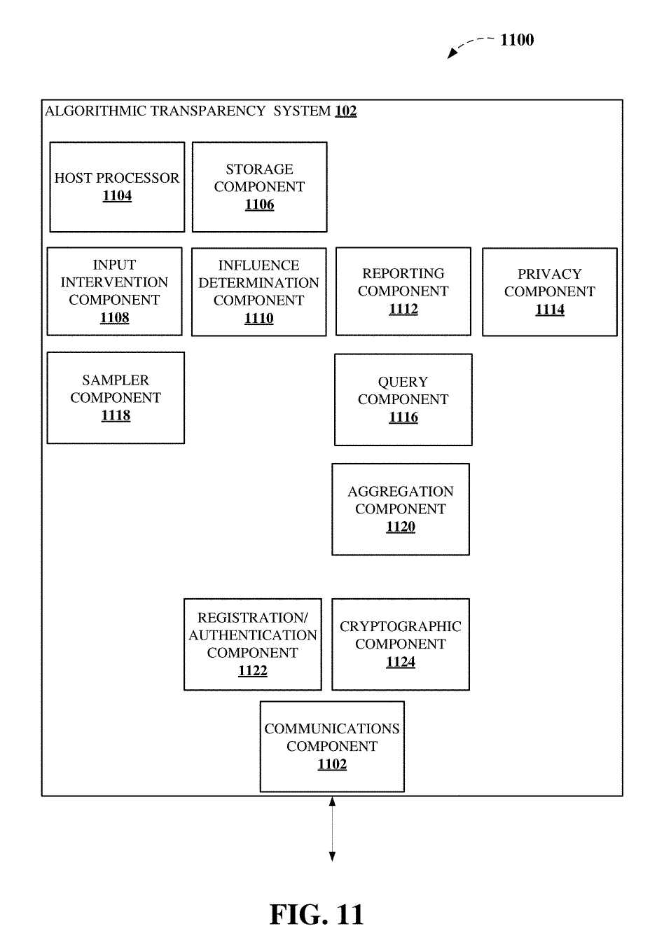

FIG. 11 depicts a functional block diagram illustrating exemplary non-limiting devices or systems suitable for use with aspects of the disclosed subject matter. For instance, FIG. 11 illustrates exemplary non-limiting devices or systems 1100 suitable for performing various aspects of the disclosed subject matter in accordance with an exemplary algorithmic transparency system 102 operatively coupled to an exemplary algorithmic decision-making system 104, as further described herein. For example, as described above regarding FIGS. 1, 4-6, etc., an exemplary algorithmic transparency system 102 operatively can be operatively coupled to, and can interact with, an exemplary algorithmic decision-making system 104, e.g., via an communications component 1102 (e.g., comprising or an associated with an interface, such as an API, etc., or portions thereof, and so on). As further depicted in FIG. 11, exemplary algorithmic transparency system 102 can comprise one or more of host processor 1104, storage component 1106, input intervention component 1108, influence determination component 1110, reporting component 1112, privacy component 1114, query component 1116, sampler component 1118, aggregation component 1120, registration and/or authentication component 1122, and/or cryptographic component 1124, as further described herein.

For instance, as described herein, exemplary algorithmic transparency system 102 comprising an exemplary communications component 1102 can facilitate transmitting information to, and/or receiving information from, exemplary algorithmic decision-making system 104 via one or more devices configured to transmit and receive information via a wireless data network (e.g., cellular wireless, Wireless Fidelity (WiFi™), Worldwide Interoperability for Microwave Access (WiMax®), etc.). In yet other non-limiting implementations of exemplary algorithmic transparency system 102 comprising an exemplary communications component 1102, exemplary algorithmic transparency system 102 can facilitate transmitting information to, and/or receiving information from, exemplary algorithmic decision-making system 104 via one or more devices configured to transmit and receive information via a voice network (e.g., cellular wireless voice network, analog or digital fixed line network, such as via conventional land-line networks, etc.). In further non-limiting implementations of exemplary algorithmic transparency system 102 comprising an exemplary communications component 1102, exemplary algorithmic transparency system 102 can facilitate transmitting information to, and/or receiving information from, exemplary algorithmic transparency system 102 via one or more devices configured to transmit and receive information via a data network supporting conventional web browsing protocols and/or applications (e.g., such as via a data connected device connected to an intranet, the Internet, wireless networks, etc.).

In still other exemplary implementations of exemplary algorithmic transparency system 102 comprising communications component 1102, exemplary algorithmic transparency system 102 can facilitate transmitting information to, and/or receiving information from, exemplary algorithmic decision-making system 104 via one or more devices configured to transmit and receive information via other technologies (e.g., mesh networks, ad hoc networks, personal area networks, interactive television, wearable computing devices, facial recognition, video telephony via any of a number of networks including the Internet, wireless networks, and so on, etc., near field communications (NFC) techniques including communications protocols and data exchange formats, such as those based on radio-frequency identification (RFID) techniques, quick response codes (QR Codes®), barcodes, voice recognition, and so on, etc.), without limitation.

At this point, it should be noted that, while a number of components and/or systems are depicted in FIG. 11, and/or are described herein with respect to exemplary algorithmic transparency system 102 comprising various components and/or systems, various non-limiting implementations of exemplary algorithmic transparency system 102 and/or devices can comprise and/or interact with exemplary algorithmic transparency system 102 are not so limited. For instance, it can be understood that, depending on the context of the interaction with exemplary algorithmic transparency system 102 and/or a device or system associated therewith, such a device or system associated with a user or subscriber 102 (or other entity) can comprise any of a number of components, subcomponents, and/or portions thereof depicted in FIG. 11, and/or can comprise such components, subcomponents, and/or portions thereof in lieu of, in addition to, and/or complementary to components depicted in FIG. 11. As a non-limiting example, a device (e.g., such as a mobile device) associated with exemplary algorithmic decision-making system 104 can comprise a user interface and/or a web browser, subcomponents, and/or portions thereof that are complementary (e.g., that can serve as a client of a server) to communications component 1102 of various implementations of exemplary algorithmic transparency system 102 (e.g., that serve as the server to the client). In a further non-limiting example, a device (e.g., such as a mobile device) associated with exemplary algorithmic decision-making system 104 can comprise any of a number of components, subcomponents, and/or portions thereof that can be employed in lieu of (or at least partially in lieu of) components depicted in FIG. 11 (e.g., such as an application, or app, programmed in native code for the particular device, etc.) that accomplishes and/or facilitates functionalities, or portions thereof, associated with components depicted in FIG. 11.

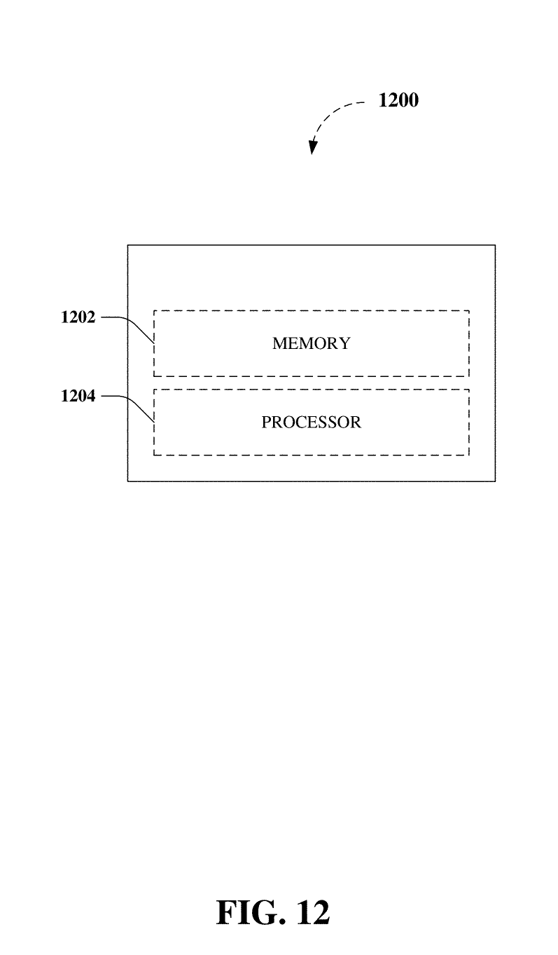

Thus, FIG. 11 illustrates an exemplary non-limiting device or system 1100 suitable for performing various aspects of the disclosed subject matter. As described below with reference to FIG. 12, for example, various non-limiting embodiments of the disclosed subject matter can comprise more or less functionality than those exemplary devices or systems described therein, depending on the context. In addition, a device or system 1100 as described can be any of the devices and/or systems as the context requires and as further described above in connection with FIGS. 1, 4-6, etc. It can be understood that while the functionality of device or system 1100 is described in a general sense, more or less of the described functionality may be implemented, combined, and/or distributed (e.g., among network components, servers, databases, and the like), according to context, system design considerations, and/or marketing factors, and the like. For the purposes of illustration and not limitation, exemplary non-limiting devices or systems 1100 can comprise one or more exemplary devices and/or systems of FIG. 12, such as exemplary algorithmic transparency system 102, as described below, for example, or portions thereof.

Referring again to FIG. 11, exemplary algorithmic transparency system 102 comprising device or system 1100, or portions thereof, can also include a communications component 1102, which can be associated with one or more host processors 1104, and which can facilitate various aspects of the disclosed subject matter. For instance, communications component 1102 can provide various types of user interfaces to facilitate interaction between exemplary algorithmic decision-making system 104 (e.g., a device on behalf of exemplary algorithmic decision-making system 104, an appropriately configured application, or app, such as an app appropriately configured for a specific device, communications service carrier, etc.) and any component coupled to, or associated with, one or more host processors 1104, exemplary algorithmic transparency system 102, and so on. In addition to being configured or adapted to be accessed by exemplary algorithmic decision-making system 104, communications component 1102, can be further configured to provide one or more GUIs, command line interfaces (CLIs), machine accessible interfaces (e.g., APIs such as e-commerce and/or MIS back-end interfaces), structured and/or customized menus, and the like. In yet another exemplary implementation, communications component 1102 can facilitate interaction between exemplary algorithmic decision-making system 104, such as between a mobile device native app installed directly onto the device (e.g., smartphone, tablet, etc.) coded in its own native programming language, and/or a mobile web app (e.g., an Internet-enabled app, etc.) that has specific functionality for mobile devices and accessed through the mobile device's web browser, as further described herein.

For example, an exemplary algorithmic transparency system 102 comprising communications component 1102 can facilitate rendering a GUI that can provide a user with a region (e.g., region of a device screen, such as via an operating system (OS), application, or otherwise, etc.) or other means to load, import, read, etc., data and/or information, and/or can include a region to present results (e.g., transparency reports, etc.) output from exemplary algorithmic transparency system 102. These regions can comprise known text and/or graphic regions comprising dialogue boxes, static controls, drop-down-menus, list boxes, pop-up menus, edit controls, combo boxes, radio buttons, check boxes, push buttons, and/or graphic boxes, and the like. In addition, utilities to facilitate the presentation such as vertical and/or horizontal scroll bars for navigation and toolbar buttons to determine whether a region will be viewable can be employed. For example, a user or subscriber may be provided with functionality to interact with one or more of the components depicted in FIG. 11, for instance, whether associated with, coupled to, and/or incorporated in one or more host processors 1104 exemplary algorithmic transparency system 102, and so on.

Exemplary algorithmic transparency system 102 comprising communications component 1102 can facilitate user interaction with such regions to select and/or provide information via various devices such as a mouse, a roller ball, a keypad, a keyboard, touchpad, touch screen, a pen and/or voice activation, for example. Typically, a mechanism such as a push button or the enter key on the keyboard can be employed to facilitate entering information in a device associated with user or subscriber 102 to facilitate interaction with exemplary algorithmic transparency system 102 comprising device or system 1100, or portions thereof. However, it is to be understood that the claimed subject matter is not so limited. In a non-limiting example, merely highlighting a check box can initiate information conveyance.

In yet another example, a command line interface (CLI) can be employed. For example, the command line interface can prompt (e.g., via a text message on a display and/or an audio tone, etc.) user for information via providing a text message. Thus, a user can provide suitable information, such as alpha-numeric input corresponding to an option provided in the interface prompt or an answer to a question posed in the prompt. It is to be understood that a command line interface can be employed in connection with a GUI and/or API. In addition, the command line interface can be employed in connection with hardware (e.g., video cards of a computer) and/or displays (e.g., black and white, EGA, or other video display unit of a standalone device such as an LCD display on a network capable device) with limited graphic support, and/or low bandwidth communication channels. As a further example, a device associated with a user that facilitates interaction with exemplary algorithmic transparency system 102 comprising device or system 1100 can include one or more motion sensors and associated software components, voice activation components, and/or facial recognition components that can be used by a user to facilitate entering information into exemplary algorithmic transparency system 102 comprising device or system 1100, or portions thereof.

Thus, in exemplary non-limiting implementations, exemplary algorithmic transparency system 102 can facilitate a user interfacing with exemplary algorithmic transparency system 102 via a mobile device, a phone, a web browser, and/or other media and/or device types, as well as facilitating interaction with exemplary algorithmic decision-making system 104 (e.g., via one or more of input intervention component 1108, influence determination component 1110, reporting component 1112, and so on, etc.). In further non-limiting implementations, exemplary algorithmic transparency system 102 comprising communications component 1102 can facilitate transforming any of a variety of input formats (e.g., data, voice, video, and so on, etc.) into a common data format and/or transmitting input formats and/or common data format. Moreover, any of the components described herein (e.g., one or more of communications component 1102, input intervention component 1108, influence determination component 1110, reporting component 1112, and so on, etc.) can be configured to perform the described functionality (e.g., via computer-executable instructions stored in a tangible computer readable medium, and/or executed by a computer, a processor, etc.), as further described herein. Accordingly, in further exemplary implementations, exemplary algorithmic transparency system 102 comprising device or system 1100, or portions thereof, can also include a communications component 1102 configured to transmit a set of inputs (e.g., intervention inputs 110) to the algorithmic decision-making system 102 or receive information (e.g., one or more outcomes 108) representative of the behavior of the algorithmic decision-making system 104 for the input intervention distribution.

Referring again to FIG. 11, in a further exemplary implementation, exemplary algorithmic transparency system 102 comprising device or system 1100, or portions thereof, can also include an input intervention component 1108 that can be configured to generate a set of inputs for an algorithmic decision-making system (e.g., algorithmic decision-making system 104), wherein the set of inputs (e.g., intervention inputs 1110) comprise an input intervention distribution based on a distribution of inputs of a population analyzed by the algorithmic decision-making system 104. In further exemplary implementations, exemplary algorithmic transparency system 102 comprising device or system 1100, or portions thereof, can also include an influence determination component 1110 configured to determine one or more Quantitative Input Influence (QII) measures for the algorithmic decision-making system 104, wherein the one or more QII measures can describes degree of influence of a subset of the set of inputs (e.g., intervention inputs 1110) on an outcome 108 that represents a property of a behavior of the algorithmic decision-making system 104 for the input intervention distribution (e.g., intervention inputs 1110). In a non-limiting aspect, one or QII measures can be associated with one or more of influence of individual inputs of the subset of the set of inputs (e.g., intervention inputs 1110), influence of correlated inputs of the subset of the set of inputs (e.g., intervention inputs 1110), joint influence of multiple inputs of the subset of the set of inputs (e.g., intervention inputs 1110), and/or marginal influence of each of the multiple inputs of the subset of the set of inputs (e.g., intervention inputs 1110), as further described herein. In a further non-limiting aspect, the input intervention distribution (e.g., intervention inputs 1110) can be generated based on the distribution of inputs of the population (e.g., via sampler component 1118, etc.) analyzed by the algorithmic decision-making system 104 and an aspect of a decision-making model associated with the algorithmic decision-making system 104 for the distribution of inputs of the population analyzed by the algorithmic decision-making system 104.

In further exemplary implementations, exemplary algorithmic transparency system 102 comprising device or system 1100, or portions thereof, can also include a reporting component 1112 configured to generate one or more transparency reports related to the one or more QII measures, wherein the one or more transparency report is based on one or more transparency queries (e.g., via query component 1116, etc.) associated with the one or QII measures. As a non-limiting example, as further described herein, the one or more transparency reports can be based on one or more transparency schema comprising the outcome 108, the input intervention distribution (e.g., intervention inputs 1110), a difference measure associated with a difference between the outcome 108 and another quantity of interest that represents another property of another behavior of the algorithmic decision-making system, and an aggregation that combines the one or more QII measures with one or more other QII measures across different sets of inputs of the set of inputs (e.g., intervention inputs 1110). In a further non-limiting example, the one or more transparency reports can comprise one or more of an input-based transparency report that can be associated with the subset of the set of inputs (e.g., intervention inputs 1110), an individual-based transparency report associated with an individual of the population analyzed by the algorithmic decision-making system 104, or a group-based transparency report associated with a group of individuals of the population analyzed by the algorithmic decision-making system 104, wherein each of the group of individuals are represented by the subset of the set of inputs (e.g., intervention inputs 1110) or the behavior of the algorithmic decision-making system 104, according to further non-limiting aspects.

In further exemplary implementations, exemplary algorithmic transparency system 102 comprising device or system 1100, or portions thereof, can also include a privacy component 1114 that can be configured to add a predetermined measure of noise to the subset of the set of inputs (e.g., intervention inputs 1110) based on sensitivity of the one or more QII measures to maintain privacy for the population analyzed by the algorithmic decision-making system 104 in the one or more transparency reports. In further exemplary implementations, exemplary algorithmic transparency system 102 comprising device or system 1100, or portions thereof, can also include a query component 1116 configured to receive the one or more transparency queries associated with the one or more QII measures and determine for the one or more transparency queries one or more statistical properties of the behavior of the algorithmic decision-making system 104, wherein the one or more statistical properties can comprise one or more of a probability of an outcome (e.g., outcome 108) of the algorithmic decision-making system 104 for the subset of the set of inputs (e.g., intervention inputs 1110), a conditional probability of the outcome (e.g., outcome 108) for the individual of the population, the conditional probability of the outcome (e.g., outcome 108) for the group of individuals of the population, or a ratio of conditional probabilities for outcomes (e.g., outcomes 108) for two different groups of individuals of the population analyzed by the algorithmic decision-making system 104.

In still further exemplary implementations, exemplary algorithmic transparency system 102 comprising device or system 1100, or portions thereof, can also include a sampler component 1118 configured to sample the distribution of inputs 106 of the population analyzed by the algorithmic decision-making system 104 to facilitate generating the set of inputs (e.g., intervention inputs 1110) comprising the input intervention distribution. In other exemplary implementations, exemplary algorithmic transparency system 102 comprising device or system 1100, or portions thereof, can also include an aggregation component 1120 configured to determine average marginal influence for the one or more QII measures using aggregation measures comprising one or more of a Shapley value, a Banzhaf index, or a Deegan-Packel index.

Referring again to FIG. 11, in further exemplary implementations, exemplary algorithmic transparency system 102 can comprise one or more of storage component 1106 query component 1116, sampler component 1118, aggregation component 1120, registration and/or authentication component 1122, cryptographic component 1124, and so on, etc., without limitation. As described above, an exemplary algorithmic transparency system 102 comprising device or system 1100, or portions thereof, can include one or more host processors 1104 that can be associated with one or more of storage component 1106 query component 1116, sampler component 1118, aggregation component 1120, registration and/or authentication component 1122, cryptographic component 1124, and so on, etc., without limitation. As a non-limiting example, computer-executable instructions associated with one or more of storage component 1106 query component 1116, sampler component 1118, aggregation component 1120, registration and/or authentication component 1122, cryptographic component 1124, and so on, etc., without limitation can be stored via storage component 1106 and/or executed via one or more host processors 1104. For instance, as described above, exemplary algorithmic transparency system 102 can facilitate performing the described functionality (e.g., via computer-executable instructions stored in a tangible computer readable medium, and/or executed by a computer, a processor, etc.).

For still other non-limiting implementations, exemplary algorithmic transparency system 102 comprising device or system 1100, or portions thereof, can also include storage component 1106 (e.g., which can comprise one or more of local storage component 608, network storage component 610, memory 1202, and so on, etc.) that can facilitate storage and/or retrieval of data and/or information associated with exemplary algorithmic transparency system 102. Thus, as described above, an exemplary algorithmic transparency system 102 comprising device or system 1100, or portions thereof, can include one or more host processors 1104 that can be associated with storage component 1106 to facilitate storage of data and/or information (e.g., inputs 106, outcomes 108, intervention, inputs 110, influences/explanations 112, analyses, transparency reports, account and/or authentication information, and so on, etc.), and/or instructions for performing functions associated with and/or incident to the disclosed subject matter as described herein, for example, regarding FIGS. 1-10, etc.

It can be understood that storage component 1106 can comprise one or more stores components, and/or portions thereof, to facilitate any of the functionality described herein and/or ancillary thereto, such as by execution of computer-executable instructions by a computer, a processor, and so on, etc. (e.g., one or more of host processors 1104, processor 1204, and so on, etc.). Moreover, any of the components described herein (e.g., storage component 1106, and so on, etc.) can be configured to perform the described functionality (e.g., via computer-executable instructions stored in a tangible computer readable medium, and/or executed by a computer, a processor, etc.). Accordingly, one or more of host processors 1104 can be associated with storage component 1106 to facilitate functionality described herein. For instance, various non-limiting implementations of exemplary algorithmic transparency system 102 can comprise one or more of one or more databases, associated data structures, database management systems (DBMS), and so on, and the like can facilitate organized storage of any of the data and/or information types or categories (or subsets thereof) as described herein (e.g., information, and/or analyses from sources other than exemplary algorithmic transparency system 102, and so on, etc.), without limitation.

Moreover, any of the components described herein (e.g., storage component 1106, input intervention component 1108, influence determination component 1110, reporting component 1112, privacy component 1114, query component 1116, sampler component 1118, aggregation component 1120, and so on, etc.) can be configured to perform the described functionality (e.g., via computer-executable instructions stored in a tangible computer readable medium, and/or executed by a computer, a processor, etc.). For instance, an exemplary non-limiting implementation of exemplary algorithmic transparency system 102 can comprise a memory or other tangible computer-readable medium (e.g., storage component 1106, etc.) to store computer-executable components and a processor communicatively coupled to the memory or other computer-readable medium (e.g., one or more host processors 1104, and so on, etc.) that can facilitate execution of the computer-executable components.

In an exemplary implementation, exemplary algorithmic transparency system 102 comprising device or system 1100, or portions thereof, can further include a registration and/or authentication component 1122 that can solicit authentication data from user or exemplary algorithmic decision-making system 104 or other device (e.g., via an operating system, and/or application software, etc.) on behalf of user or exemplary algorithmic decision-making system 104, and, upon receiving authentication data so solicited, can be employed, individually and/or in conjunction with information acquired and ascertained as a result of biometric modalities employed (e.g., facial recognition, voice recognition, etc.), to facilitate registering a user or exemplary algorithmic decision-making system 104, or a computer or device on behalf of user or exemplary algorithmic decision-making system 104, creating an account on behalf of user or exemplary algorithmic decision-making system 104, associating a device with a user or exemplary algorithmic decision-making system 104, verifying received authentication data, and so on. The authentication data can be in the form of a password (e.g., a sequence of humanly cognizable characters), a pass phrase (e.g., a sequence of alphanumeric characters that can be similar to a typical password but is conventionally of greater length and contains non-humanly cognizable characters in addition to humanly cognizable characters), a pass code (e.g., Personal Identification Number (PIN)), and the like, for example.

Additionally and/or alternatively, public key infrastructure (PM) data can also be employed by registration and/or authentication component 1122. PKI arrangements can provide for trusted third parties to vet, and affirm, entity identity through the use of public keys that typically can be certificates issued by trusted third parties. Such arrangements can enable entities to be authenticated to each other, and to use information in certificates (e.g., public keys) and private keys, session keys, Traffic Encryption Keys (TEKs), cryptographic-system-specific keys, and/or other keys, to encrypt and decrypt messages communicated between entities.

Accordingly, registration and/or authentication component 1122 can implement one or more machine-implemented techniques to identify a user or exemplary algorithmic decision-making system 104 or other device (e.g., via an operating system and/or application software) on behalf of the user, by the user's unique physical and behavioral characteristics and attributes. Biometric modalities that can be employed can include, for example, face recognition wherein measurements of key points on an entity's face can provide a unique pattern that can be associated with the entity, iris recognition that measures from the outer edge towards the pupil the patterns associated with the colored part of the eye—the iris—to detect unique features associated with an entity's iris, voice recognition, and/or finger print identification that scans the corrugated ridges of skin that are non-continuous and form a pattern that can provide distinguishing features to identify an entity. Moreover, any of the components described herein (e.g., registration and/or authentication component 1122, and so on, etc.) can be configured to perform the described functionality (e.g., via computer-executable instructions stored in a tangible computer readable medium, and/or executed by a computer, a processor, etc.).

In other non-limiting implementations, exemplary algorithmic transparency system 102 comprising device or system 1100, or portions thereof, can also include cryptographic component 1124 that can facilitate encrypting and/or decrypting data and/or information associated with exemplary algorithmic transparency system 102 to protect such sensitive data and/or information associated with user or subscriber 102, such as authentication data, data and/or information employed to confirm various user or subscriber 102 demographics, usage history, search history, and so on, etc. Thus, one or more of host processors 1104 can be associated with cryptographic component 1124. In accordance with an aspect of the disclosed subject matter, cryptographic component 1124 can provide symmetric cryptographic tools and accelerators (e.g., Twofish, Blowfish, AES, TDES, IDEA, CAST5, RC4, etc.) to facilitate encrypting and/or decrypting data and/or information associated with exemplary algorithmic transparency system 102.

Thus, cryptographic component 1124 can facilitate securing data and/or information being written to, stored in, and/or read from the storage component 1106 (e.g., inputs 106, outcomes 108, intervention, inputs 110, influences/explanations 112, analyses, transparency reports, account and/or authentication information, and so on, etc.), transmitted to and/or received from a connected network, and/or creating a secure communication channel as part of a secure association of various devices with exemplary implementations of exemplary algorithmic transparency system 102 comprising non-limiting embodiments of devices or systems 1100, or portions thereof, with exemplary algorithmic decision-making systems 104 facilitating various aspects of the disclosed subject matter to ensure that protected data can only be accessed by those entities authorized and/or authenticated to do so. To the same ends, cryptographic component 1124 can also provide asymmetric cryptographic accelerators and tools (e.g., RSA, Digital Signature Standard (DSS), and the like) in addition to accelerators and tools (e.g., Secure Hash Algorithm (SHA) and its variants such as, for example, SHA-0, SHA-1, SHA-224, SHA-256, SHA-384, SHA-512, SHA-3, and so on). As described, any of the components described herein (e.g., cryptographic component 1124, and so on, etc.) can be configured to perform the described functionality (e.g., via computer-executable instructions stored in a tangible computer readable medium, and/or executed by a computer, a processor, etc.).

It should be noted that, as depicted in FIG. 11, devices or systems 1100 are described as monolithic devices or systems. However, it is to be understood that the various components and/or the functionality provided thereby can be incorporated into one or more host processors 1104 or provided by one or more other connected devices. Accordingly, it is to be understood that more or less of the described functionality may be implemented, combined, and/or distributed (e.g., among network devices or systems, servers, databases, and the like), according to context, system design considerations, and/or marketing factors. Moreover, any of the components described herein can be configured to perform the described functionality (e.g., via computer-executable instructions stored in a tangible computer readable medium, and/or executed by a computer, a processor, etc.).

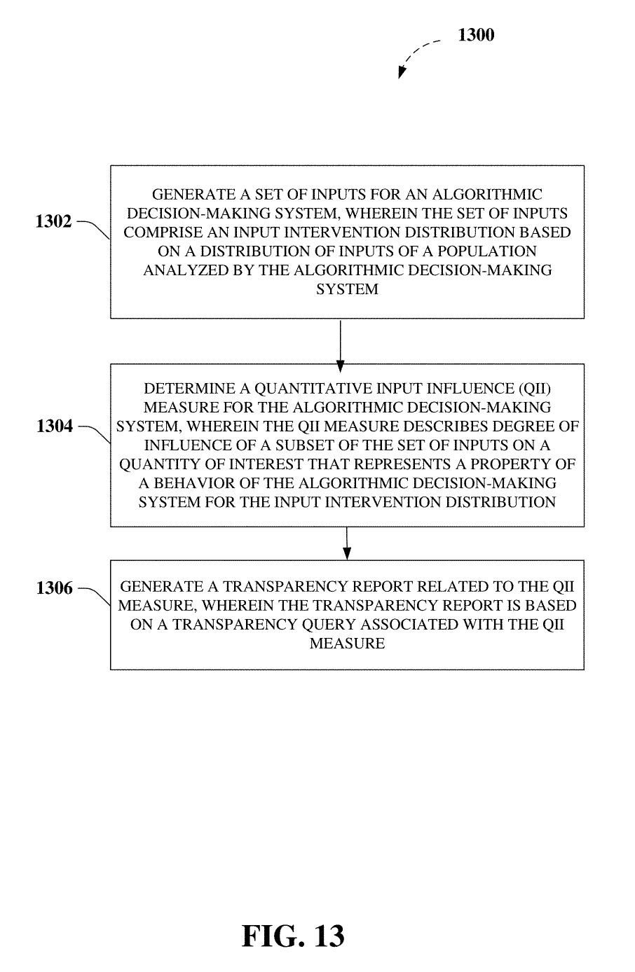

FIG. 12 illustrates an exemplary non-limiting device or system 1200 suitable for performing various aspects of the disclosed subject matter. The device or system 1200 can be a stand-alone device or a portion thereof, a specially programmed computing device or a portion thereof (e.g., a memory retaining instructions for performing the techniques as described herein coupled to a processor), and/or a composite device or system comprising one or more cooperating components distributed among several devices, as further described herein. As an example, exemplary non-limiting device or system 1200 can comprise exemplary devices and/or systems regarding FIGS. 1, 4-6, and 10 as described above, or as further described below regarding FIGS. 13-15, or portions thereof.

Accordingly, device or system 1200 can include a memory 1202 that retains various instructions with respect to facilitating various operations, for example, such as: generating a set of inputs (e.g., intervention inputs 110) for an algorithmic decision-making system 104, wherein the set of inputs (e.g., intervention inputs 110) comprise an input intervention distribution based on a distribution of inputs of a population analyzed by the algorithmic decision-making system 104; determining one or more Quantitative Input Influence (QII) measures for the algorithmic decision-making system 104, wherein the one or more QII measures describe degree of influence of a subset of the set of inputs (e.g., intervention inputs 110) on an outcome 108 that represents a property of a behavior of the algorithmic decision-making system 104 for the input intervention distribution; generating one or more transparency reports (e.g., influences/explanations 112) related to the one or more QII measures, wherein the one or more transparency reports (e.g., influences/explanations 112) can be based on one or more transparency queries (e.g., via query component 1116) associated with the one or more QII measures; encryption; decryption; various user interfaces; and/or communications routines such as networking, and/or the like.

In addition, device or system 1200 can include a memory 1202 that retains instructions with respect to facilitating various operations, for example, such as: determining the one or more QII that is associated with one or more of influence of individual inputs of the subset of the set of inputs (e.g., intervention inputs 110), influence of correlated inputs of the subset of the set of inputs (e.g., intervention inputs 110), joint influence of multiple inputs of the subset of the set of inputs (e.g., intervention inputs 110), or marginal influence of each of the multiple inputs of the subset of the set of inputs (e.g., intervention inputs 110); generating the one or more transparency reports (e.g., influences/explanations 112) based on one or more transparency schema comprising the outcome, the input intervention distribution, a difference measure associated with a difference between the outcome 108 and another quantity of interest that represents another property of another behavior of the algorithmic decision-making system 104, and an aggregation that combines the one or more QII measures with one or more other QII measure across different sets of inputs of the set of inputs (e.g., intervention inputs 110); adding a predetermined measure of noise to the subset of the set of inputs (e.g., intervention inputs 110) based on sensitivity of the one or more QII measures to maintain privacy for the population analyzed by the algorithmic decision-making system 104 in the one or more transparency reports (e.g., influences/explanations 112); generating the one or more transparency reports (e.g., influences/explanations 112) comprising one or more of an input-based transparency report that is associated with the subset of the set of inputs (e.g., intervention inputs 110), an individual-based transparency report associated with an individual of the population analyzed by the algorithmic decision-making system 104, or a group-based transparency report associated with a group of individuals of the population analyzed by the algorithmic decision-making system 104, wherein each of the group of individuals are represented by the subset of the set of inputs (e.g., intervention inputs 110) or the behavior of the algorithmic decision-making system 104; and so on.

Additionally, memory 1202 can retain instructions for receiving the one or more transparency queries (e.g., via query component 1116) associated with the one or more QII measures, and determining for the one or more transparency queries (e.g., via query component 1116) one or more statistical property of the behavior of the algorithmic decision-making system 104, wherein the one or more statistical property comprises one or more of a probability of an outcome 108 of the algorithmic decision-making system 104 for the subset of the set of inputs (e.g., intervention inputs 110), a conditional probability of the outcome 108 for the individual of the population, the conditional probability of the outcome 108 for the group of individuals of the population, or a ratio of conditional probabilities for outcomes for two different groups of individuals of the population analyzed by the algorithmic decision-making system 104.

Additionally, memory 1202 can retain instructions for sampling the distribution of inputs of the population analyzed by the algorithmic decision-making system 104 to facilitate generating the set of inputs (e.g., intervention inputs 110) comprising the input intervention distribution, and/or the like. In further non-limiting examples, memory 1202 can retain instructions for determining average marginal influence for the one or more QII measures using aggregation measures comprising one or more of a Shapley value, a Banzhaf index, or a Deegan-Packel index; transmitting the set of inputs (e.g., intervention inputs 110) to the algorithmic decision-making system 104; receiving information representative of the behavior of the algorithmic decision-making system 104 for the input intervention distribution; and/or the like.

The above example instructions and other suitable instructions for functionalities as described herein for example, regarding FIGS. 1-11 and 13-15, etc., can be retained within memory 1202, and a processor 1204 can be utilized in connection with executing the instructions.

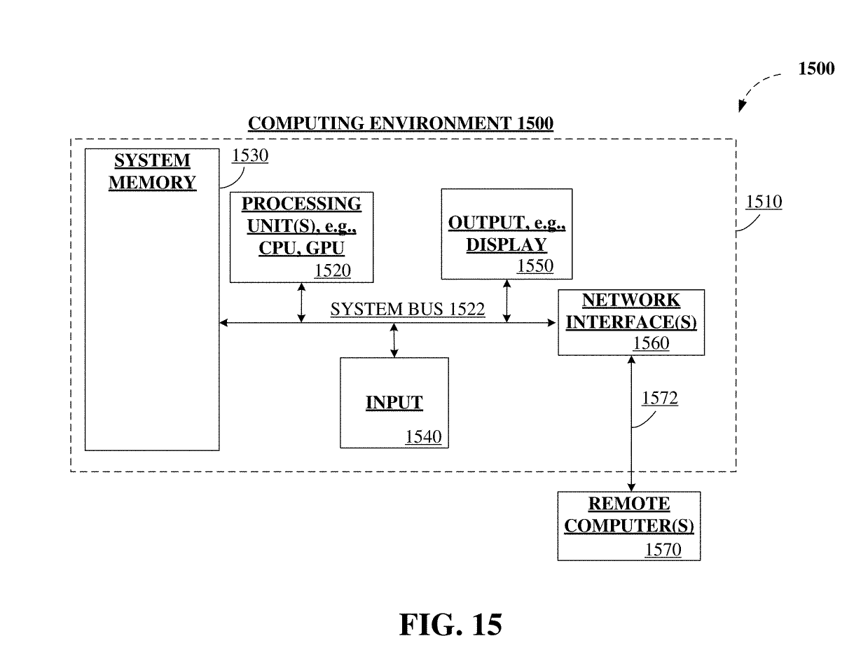

In view of the exemplary embodiments described supra, methods that can be implemented in accordance with the disclosed subject matter will be better appreciated with reference to the flowcharts of FIG. 15. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks may be required to implement the methods described hereinafter. Additionally, it should be further understood that the methods and/or functionality disclosed hereinafter and throughout this specification are capable of being stored on an article of manufacture to facilitate transporting and transferring such methods to computers, for example, as further described herein. The terms computer readable medium, article of manufacture, and the like, as used herein, are intended to encompass a computer program accessible from any computer-readable device or media.

### Exemplary Methods

FIG. 13 illustrates an exemplary non-limiting flow diagram of methods 1300 for performing aspects of embodiments of the disclosed subject matter. In a non-limiting example, exemplary methods 1300 can comprise generating a set of inputs (e.g., intervention inputs 110) for an algorithmic decision-making system 104, wherein the set of inputs (e.g., intervention inputs 110) comprise an input intervention distribution based on a distribution of inputs of a population analyzed by the algorithmic decision-making system 104, at 1302.

In yet another example, non-limiting implementations of methods 1300 can, at 1304, determining one or more Quantitative Input Influence (QII) measures for the algorithmic decision-making system 104, wherein the one or more QII measures describe degree of influence of a subset of the set of inputs (e.g., intervention inputs 110) on an outcome 108 that represents a property of a behavior of the algorithmic decision-making system 104 for the input intervention distribution, as further described herein. In a non-limiting aspect, exemplary methods 1300 can comprise determining the one or more QII that is associated with one or more of influence of individual inputs of the subset of the set of inputs (e.g., intervention inputs 110), influence of correlated inputs of the subset of the set of inputs (e.g., intervention inputs 110), joint influence of multiple inputs of the subset of the set of inputs (e.g., intervention inputs 110), or marginal influence of each of the multiple inputs of the subset of the set of inputs (e.g., intervention inputs 110).

As described above, methods 1300 can further include, at 1306, generating one or more transparency reports (e.g., influences/explanations 112) related to the one or more QII measures, wherein the one or more transparency reports (e.g., influences/explanations 112) can be based on one or more transparency queries (e.g., via query component 1116) associated with the one or more QII measures. For instance, exemplary implementations of methods 1300 can also comprise generating the one or more transparency reports (e.g., influences/explanations 112) that are based on one or more transparency schema comprising the outcome, the input intervention distribution, a difference measure associated with a difference between the outcome 108 and another quantity of interest that represents another property of another behavior of the algorithmic decision-making system 104, and an aggregation that combines the one or more QII measures with one or more other QII measure across different sets of inputs of the set of inputs (e.g., intervention inputs 110), in further non-limiting aspects. In other non-limiting implementations, exemplary methods 1300 can comprise generating the one or more transparency reports (e.g., influences/explanations 112) that comprises one or more of an input-based transparency report that is associated with the subset of the set of inputs (e.g., intervention inputs 110), an individual-based transparency report associated with an individual of the population analyzed by the algorithmic decision-making system 104, or a group-based transparency report associated with a group of individuals of the population analyzed by the algorithmic decision-making system 104, wherein each of the group of individuals are represented by the subset of the set of inputs (e.g., intervention inputs 110) or the behavior of the algorithmic decision-making system 104.

In addition, exemplary methods 1300 can further include adding a predetermined measure of noise to the subset of the set of inputs (e.g., intervention inputs 110) based on sensitivity of the one or more QII measures to maintain privacy for the population analyzed by the algorithmic decision-making system 104 in the one or more transparency reports (e.g., influences/explanations 112), as further described herein. In still further non-limiting implementations of exemplary methods 1300, as further described herein, exemplary methods 1300 can comprise receiving the one or more transparency queries (e.g., via query component 1116) associated with the one or more QII measures, and/or determining for the one or more transparency queries (e.g., via query component 1116) one or more statistical property of the behavior of the algorithmic decision-making system 104, wherein the one or more statistical property comprises one or more of a probability of an outcome 108 of the algorithmic decision-making system 104 for the subset of the set of inputs (e.g., intervention inputs 110), a conditional probability of the outcome 108 for the individual of the population, the conditional probability of the outcome 108 for the group of individuals of the population, or a ratio of conditional probabilities for outcomes for two different groups of individuals of the population analyzed by the algorithmic decision-making system 104. In addition, exemplary methods 1300 can further comprise sampling the distribution of inputs of the population analyzed by the algorithmic decision-making system 104 to facilitate generating the set of inputs (e.g., intervention inputs 110) comprising the input intervention distribution, according to further non-limiting aspects. Exemplary methods 1300 can further comprise determining average marginal influence for the one or more QII measures using aggregation measures comprising one or more of a Shapley value, a Banzhaf index, or a Deegan-Packel index, in still further non-limiting aspects.

### Exemplary Networked and Distributed Environments

One of ordinary skill in the art can appreciate that the various embodiments of the disclosed subject matter and related systems, devices, and/or methods described herein can be implemented in connection with any computer or other client or server device, which can be deployed as part of a communications system, a computer network, and/or in a distributed computing environment, and can be connected to any kind of data store. In this regard, the various embodiments described herein can be implemented in any computer system or environment having any number of memory or storage units, and any number of applications and processes occurring across any number of storage units or volumes, which may be used in connection with communication systems using the techniques, systems, and methods in accordance with the disclosed subject matter. The disclosed subject matter can apply to an environment with server computers and client computers deployed in a network environment or a distributed computing environment, having remote or local storage. The disclosed subject matter can also be applied to standalone computing devices, having programming language functionality, interpretation and execution capabilities for generating, receiving, storing, and/or transmitting information in connection with remote or local services and processes.

Distributed computing provides sharing of computer resources and services by communicative exchange among computing devices and systems. These resources and services can include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices can have applications, objects or resources that may utilize disclosed and related systems, devices, and/or methods as described for various embodiments of the subject disclosure.

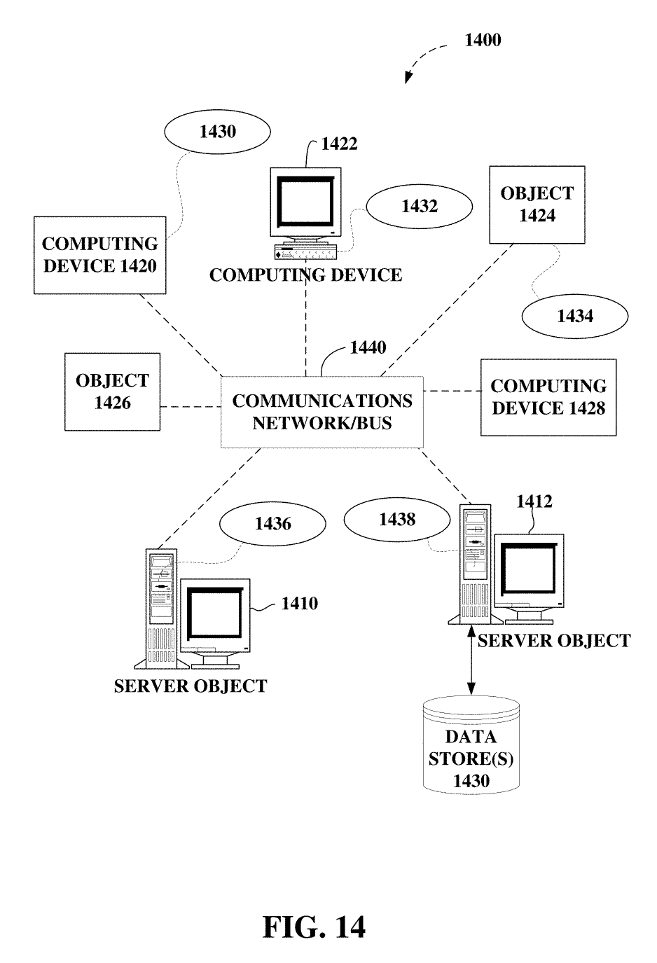

FIG. 14 provides a schematic diagram of an exemplary networked or distributed computing environment. The distributed computing environment comprises computing objects 1410, 1412, etc. and computing objects or devices 1420, 1422, 1424, 1426, 1428, etc., which may include programs, methods, data stores, programmable logic, etc., as represented by applications 1430, 1432, 1434, 1436, 1438. It can be understood that objects 1410, 1412, etc. and computing objects or devices 1420, 1422, 1424, 1426, 1428, etc. may comprise different devices, such as PDAs, audio/video devices, mobile phones, MP3 players, personal computers, laptops, etc.

Each object 1410, 1412, etc. and computing objects or devices 1420, 1422, 1424, 1426, 1428, etc. can communicate with one or more other objects 1410, 1412, etc. and computing objects or devices 1420, 1422, 1424, 1426, 1428, etc. by way of the communications network 1440, either directly or indirectly. Even though illustrated as a single element in FIG. 14, network 1440 may comprise other computing objects and computing devices that provide services to the system of FIG. 14, and/or may represent multiple interconnected networks, which are not shown. Each object 1410, 1412, etc. or 1420, 1422, 1424, 1426, 1428, etc. can also contain an application, such as applications 1430, 1432, 1434, 1436, 1438, that can make use of an API, or other object, software, firmware and/or hardware, suitable for communication with or implementation of disclosed and related systems, devices, methods, and/or functionality provided in accordance with various embodiments of the subject disclosure. Thus, although the physical environment depicted may show the connected devices as computers, such illustration is merely exemplary and the physical environment may alternatively be depicted or described comprising various digital devices, any of which can employ a variety of wired and/or wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many networks are coupled to the Internet, which can provide an infrastructure for widely distributed computing and can encompass many different networks, though any network infrastructure can be used for exemplary communications made incident to employing disclosed and related systems, devices, and/or methods as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 14, as a non-limiting example, computers 1420, 1422, 1424, 1426, 1428, etc. can be thought of as clients and computers 1410, 1412, etc. can be thought of as servers where servers 1410, 1412, etc. provide data services, such as receiving data from client computers 1420, 1422, 1424, 1426, 1428, etc., storing of data, processing of data, transmitting data to client computers 1420, 1422, 1424, 1426, 1428, etc., although any computer can be considered a client, a server, or both, depending on the circumstances. Any of these computing devices may be processing data, forming metadata, synchronizing data or requesting services or tasks that may implicate disclosed and related systems, devices, and/or methods as described herein for one or more embodiments.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to disclosed and related systems, devices, and/or methods can be provided standalone, or distributed across multiple computing devices or objects.

In a network environment in which the communications network/bus 1440 is the Internet, for example, the servers 1410, 1412, etc. can be Web servers with which the clients 1420, 1422, 1424, 1426, 1428, etc. communicate via any of a number of known protocols, such as the hypertext transfer protocol (HTTP). Servers 1410, 1412, etc. may also serve as clients 1420, 1422, 1424, 1426, 1428, etc., as may be characteristic of a distributed computing environment.

### Exemplary Computing Device

As mentioned, advantageously, the techniques described herein can be applied to devices or systems where it is desirable to employ disclosed and related systems, devices, and/or methods. It should be understood, therefore, that handheld, portable and other computing devices and computing objects of all kinds are contemplated for use in connection with the various disclosed embodiments. Accordingly, the below general purpose remote computer described below in FIG. 15 is but one example of a computing device. Additionally, disclosed and related systems, devices, and/or methods can include one or more aspects of the below general purpose computer, such as display, storage, analysis, control, etc.

Although not required, embodiments can partly be implemented via an operating system, for use by a developer of services for a device or object, and/or included within application software that operates to perform one or more functional aspects of the various embodiments described herein. Software can be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 15 thus illustrates an example of a suitable computing system environment 1500 in which one or aspects of the embodiments described herein can be implemented, although as made clear above, the computing system environment 1500 is only one example of a suitable computing environment and is not intended to suggest any limitation as to scope of use or functionality. Neither should the computing environment 1500 be interpreted as having any dependency or requirement relating to any one or combination of components illustrated in the exemplary operating environment 1500.

With reference to FIG. 15, an exemplary remote device for implementing one or more embodiments includes a general purpose computing device in the form of a computer 1510. Components of computer 1510 can include, but are not limited to, a processing unit 1520, a system memory 1530, and a system bus 1522 that couples various system components including the system memory to the processing unit 1520.

Computer 1510 typically includes a variety of computer readable media and can be any available media that can be accessed by computer 1510. The system memory 1530 can include computer storage media in the form of volatile and/or nonvolatile memory such as read only memory (ROM) and/or random access memory (RAM). By way of example, and not limitation, memory 1530 can also include an operating system, application programs, other program modules, and program data.

A user can enter commands and information into the computer 1510 through input devices 1540. A monitor or other type of display device is also connected to the system bus 1522 via an interface, such as output interface 1550. In addition to a monitor, computers can also include other peripheral output devices such as speakers and a printer, which can be connected through output interface 1550.

The computer 1510 can operate in a networked or distributed environment using logical connections to one or more other remote computers, such as remote computer 1570. The remote computer 1570 can be a personal computer, a server, a router, a network PC, a peer device or other common network node, or any other remote media consumption or transmission device, and can include any or all of the elements described above relative to the computer 1510. The logical connections depicted in FIG. 15 include a network 1572, such local area network (LAN) or a wide area network (WAN), but can also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts can be applied to any network system and any computing device or system in which it is desirable to employ disclosed and related systems, devices, and/or methods.

Also, there are multiple ways to implement the same or similar functionality, e.g., an appropriate API, tool kit, driver code, operating system, control, standalone or downloadable software object, etc. which enables applications and services to use disclosed and related systems, devices, methods, and/or functionality. Thus, embodiments herein are contemplated from the standpoint of an API (or other software object), as well as from a software or hardware object that implements one or more aspects of disclosed and related systems, devices, and/or methods as described herein. Thus, various embodiments described herein can have aspects that are wholly in hardware, partly in hardware and partly in software, as well as in software.

Those skilled in the art will recognize that it is common within the art to describe devices and/or processes in the fashion set forth herein, and thereafter use engineering practices to integrate such described devices and/or processes into systems. That is, at least a portion of the devices and/or processes described herein can be integrated into a system via a reasonable amount of experimentation. Those having skill in the art will recognize that a typical system can include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control device (e.g., feedback for sensing position and/or velocity; control devices for moving and/or adjusting parameters). A typical system can be implemented utilizing any suitable commercially available components, such as those typically found in data computing/communication and/or network computing/communication systems.

Various embodiments of the disclosed subject matter sometimes illustrate different components contained within, or connected with, other components. It is to be understood that such depicted architectures are merely exemplary, and that, in fact, many other architectures can be implemented which achieve the same and/or equivalent functionality. In a conceptual sense, any arrangement of components to achieve the same and/or equivalent functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected,” “operably coupled,” “communicatively connected,” and/or “communicatively coupled,” to each other to achieve the desired functionality, and any two components capable of being so associated can also be viewed as being “operably couplable” or “communicatively couplable” to each other to achieve the desired functionality. Specific examples of operably couplable or communicatively couplable can include, but are not limited to, physically mateable and/or physically interacting components, wirelessly interactable and/or wirelessly interacting components, and/or logically interacting and/or logically interactable components.

With respect to substantially any plural and/or singular terms used herein, those having skill in the art can translate from the plural to the singular and/or from the singular to the plural as can be appropriate to the context and/or application. The various singular/plural permutations may be expressly set forth herein for the sake of clarity, without limitation.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes, but is not limited to,” etc.). It will be further understood by those skilled in the art that, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limit any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those skilled in the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub-ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

In addition, the words “exemplary” and “non-limiting” are used herein to mean serving as an example, instance, or illustration. For the avoidance of doubt, the subject matter disclosed herein is not limited by such examples. Moreover, any aspect or design described herein as “an example,” “an illustration,” “exemplary” and/or “non-limiting” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements, as described above.

As mentioned, the various techniques described herein can be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. In addition, one or more components can reside within a process and/or thread of execution and a component can be localized on one computer and/or distributed between two or more computers.

Systems described herein can be described with respect to interaction between several components. It can be understood that such systems and components can include those components or specified sub-components, some of the specified components or sub-components, or portions thereof, and/or additional components, and various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and that any one or more middle component layers, such as a management layer, can be provided to communicatively couple to such sub-components in order to provide integrated functionality, as mentioned. Any components described herein can also interact with one or more other components not specifically described herein but generally known by those of skill in the art.

As mentioned, in view of the exemplary systems described herein, methods that can be implemented in accordance with the described subject matter can be better appreciated with reference to the flowcharts of the various figures and vice versa. While for purposes of simplicity of explanation, the methods can be shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be understood that various other branches, flow paths, and orders of the blocks, can be implemented which achieve the same or a similar result. Moreover, not all illustrated blocks can be required to implement the methods described hereinafter.

While the disclosed subject matter has been described in connection with the disclosed embodiments and the various figures, it is to be understood that other similar embodiments may be used or modifications and additions may be made to the described embodiments for performing the same function of the disclosed subject matter without deviating therefrom. Still further, multiple processing chips or multiple devices can share the performance of one or more functions described herein, and similarly, storage can be effected across a plurality of devices. In other instances, variations of process parameters (e.g., configuration, number of components, aggregation of components, process step timing and order, addition and/or deletion of process steps, addition of preprocessing and/or post-processing steps, etc.) can be made to further optimize the provided structures, devices and methods, as shown and described herein. In any event, the systems, structures and/or devices, as well as the associated methods described herein have many applications in various aspects of the disclosed subject matter, and so on. Accordingly, the invention should not be limited to any single embodiment, but rather should be construed in breadth, spirit and scope in accordance with the appended claims.

What is claimed is:

1. A system, comprising:
a memory to store computer-executable components; and
a processor communicatively coupled to the memory that facilitates execution of the computer-executable components, the computer-executable components, comprising:
an input intervention component configured to generate a set of inputs for an algorithmic decision-making system, wherein the set of inputs comprise an input intervention distribution based on a distribution of inputs of a population analyzed by the algorithmic decision-making system; and
an influence determination component configured to determine at least one Quantitative Input Influence (QII) measure for the algorithmic decision-making system, wherein the at least one QII measure describes degree of influence of at least a subset of the set of inputs on an outcome that represents a property of a behavior of the algorithmic decision-making system for the input intervention distribution.

2. The system of claim 1, wherein the at least one QII measure is associated with at least one of influence of individual inputs of the at least the subset of the set of inputs, influence of correlated inputs of the at least the subset of the set of inputs, joint influence of multiple inputs of the at least the subset of the set of inputs, or marginal influence of each of the multiple inputs of the at least the subset of the set of inputs.

3. The system of claim 1, further comprising:
a reporting component configured to generate at least one transparency report related to the at least one QII measure, wherein the at least one transparency report is based on at least one transparency query associated with the at least one QII measure.

4. The system of claim 3, wherein the at least one transparency report is based on at least one transparency schema comprising the outcome, the input intervention distribution, a difference measure associated with a difference between the outcome and another quantity of interest that represents another property of another behavior of the algorithmic decision-making system, and an aggregation that combines the at least one QII measure with at least one other QII measure across different sets of inputs of the set of inputs.

5. The system of claim 3, further comprising:
a privacy component configured to add a predetermined measure of noise to the at least the subset of the set of inputs based on sensitivity of the at least one QII measure to maintain privacy for the population analyzed by the algorithmic decision-making system in the at least one transparency report.

6. The system of claim 3, wherein the at least one transparency report comprises at least one of an input-based transparency report that is associated with the at least the subset of the set of inputs, an individual-based transparency report associated with an individual of the population analyzed by the algorithmic decision-making system, or a group-based transparency report associated with a group of individuals of the population analyzed by the algorithmic decision-making system, wherein each of the group of individuals are represented by the at least the subset of the set of inputs or the behavior of the algorithmic decision-making system.

7. The system of claim 6, further comprising:
a query component configured to receive the at least one transparency query associated with the at least one QII measure and determine for the at least one transparency query at least one statistical property of the behavior of the algorithmic decision-making system, wherein the at least one statistical property comprises at least one of a probability of an outcome of the algorithmic decision-making system for the at least the subset of the set of inputs, a conditional probability of the outcome for the individual of the population, the conditional probability of the outcome for the group of individuals of the population, or a ratio of conditional probabilities for outcomes for two different groups of individuals of the population analyzed by the algorithmic decision-making system.

8. The system of claim 1, wherein the input intervention distribution is generated based on the distribution of inputs of the population analyzed by the algorithmic decision-making system and an aspect of a decision-making model associated with the algorithmic decision-making system for the distribution of inputs of the population analyzed by the algorithmic decision-making system.

9. The system of claim 1, further comprising:
a sampler component configured to sample the distribution of inputs of the population analyzed by the algorithmic decision-making system to facilitate generating the set of inputs comprising the input intervention distribution.

10. The system of claim 1, further comprising:
a communications component configured to at least one of transmit the set of inputs to the algorithmic decision-making system or receive information representative of the behavior of the algorithmic decision-making system for the input intervention distribution.

11. The system of claim 1, further comprising:
an aggregation component configured to determine average marginal influence for the at least one QII measure using aggregation measures comprising at least one of a Shapley value, a Banzhaf index, or a Deegan-Packel index.

12. A method, comprising:
generating a set of inputs for an algorithmic decision-making system, wherein the set of inputs comprise an input intervention distribution based on a distribution of inputs of a population analyzed by the algorithmic decision-making system;
determining at least one Quantitative Input Influence (QII) measure for the algorithmic decision-making system, wherein the at least one QII measure describes degree of influence of at least a subset of the set of inputs on an outcome that represents a property of a behavior of the algorithmic decision-making system for the input intervention distribution; and
generating at least one transparency report related to the at least one QII measure, wherein the at least one transparency report is based on at least one transparency query associated with the at least one QII measure.

13. The method of claim 12, wherein the determining the at least one at least one QII comprises determining the at least one QII that is associated with at least one of influence of individual inputs of the at least the subset of the set of inputs, influence of correlated inputs of the at least the subset of the set of inputs, joint influence of multiple inputs of the at least the subset of the set of inputs, or marginal influence of each of the multiple inputs of the at least the subset of the set of inputs.

14. The method of claim 12, wherein the generating the at least one transparency report comprises generating the at least one transparency report that is based on at least one transparency schema comprising the outcome, the input intervention distribution, a difference measure associated with a difference between the outcome and another quantity of interest that represents another property of another behavior of the algorithmic decision-making system, and an aggregation that combines the at least one QII measure with at least one other QII measure across different sets of inputs of the set of inputs.

15. The method of claim 12, further comprising:
adding a predetermined measure of noise to the at least the subset of the set of inputs based on sensitivity of the at least one QII measure to maintain privacy for the population analyzed by the algorithmic decision-making system in the at least one transparency report.

16. The method of claim 12, wherein the generating the at least one transparency report comprises generating the at least one transparency report that comprises at least one of an input-based transparency report that is associated with the at least the subset of the set of inputs, an individual-based transparency report associated with an individual of the population analyzed by the algorithmic decision-making system, or a group-based transparency report associated with a group of individuals of the population analyzed by the algorithmic decision-making system, wherein each of the group of individuals are represented by the at least the subset of the set of inputs or the behavior of the algorithmic decision-making system.

17. The method of claim 16, further comprising:
receiving the at least one transparency query associated with the at least one QII measure; and
determining for the at least one transparency query at least one statistical property of the behavior of the algorithmic decision-making system, wherein the at least one statistical property comprises at least one of a probability of an outcome of the algorithmic decision-making system for the at least the subset of the set of inputs, a conditional probability of the outcome for the individual of the population, the conditional probability of the outcome for the group of individuals of the population, or a ratio of conditional probabilities for outcomes for two different groups of individuals of the population analyzed by the algorithmic decision-making system.

18. The method of claim 12, further comprising:
sampling the distribution of inputs of the population analyzed by the algorithmic decision-making system to facilitate generating the set of inputs comprising the input intervention distribution.

19. The method of claim 12, further comprising:
determining average marginal influence for the at least one QII measure using aggregation measures comprising at least one of a Shapley value, a Banzhaf index, or a Deegan-Packel index.

20. A tangible computer readable storage medium comprising computer-executable instructions that, in response to execution, cause a computing device including a processor to perform operations, comprising:
generating a set of inputs for an algorithmic decision-making system, wherein the set of inputs comprise an input intervention distribution based on a distribution of inputs of a population analyzed by the algorithmic decision-making system;
determining at least one Quantitative Input Influence (QII) measure for the algorithmic decision-making system, wherein the at least one QII measure describes degree of influence of at least a subset of the set of inputs on an outcome that represents a property of a behavior of the algorithmic decision-making system for the input intervention distribution; and
generating at least one transparency report related to the at least one QII measure, wherein the at least one transparency report is based on at least one transparency query associated with the at least one QII measure.

21. The tangible computer readable storage medium of claim 20, the operations further comprising:
determining the at least one QII that is associated with at least one of influence of individual inputs of the at least the subset of the set of inputs, influence of correlated inputs of the at least the subset of the set of inputs, joint influence of multiple inputs of the at least the subset of the set of inputs, or marginal influence of each of the multiple inputs of the at least the subset of the set of inputs.

22. The tangible computer readable storage medium of claim 20, the operations further comprising at least one of:
generating the at least one transparency report based on at least one transparency schema comprising the outcome, the input intervention distribution, a difference measure associated with a difference between the outcome and another quantity of interest that represents another property of another behavior of the algorithmic decision-making system, and an aggregation that combines the at least one QII measure with at least one other QII measure across different sets of inputs of the set of inputs;
adding a predetermined measure of noise to the at least the subset of the set of inputs based on sensitivity of the at least one QII measure to maintain privacy for the population analyzed by the algorithmic decision-making system in the at least one transparency report; or
generating the at least one transparency report comprising at least one of an input-based transparency report that is associated with the at least the subset of the set of inputs, an individual-based transparency report associated with an individual of the population analyzed by the algorithmic decision-making system, or a group-based transparency report associated with a group of individuals of the population analyzed by the algorithmic decision-making system, wherein each of the group of individuals are represented by the at least the subset of the set of inputs or the behavior of the algorithmic decision-making system

23. The tangible computer readable storage medium of claim 20, the operations further comprising:
receiving the at least one transparency query associated with the at least one QII measure; and
determining for the at least one transparency query at least one statistical property of the behavior of the algorithmic decision-making system, wherein the at least one statistical property comprises at least one of a probability of an outcome of the algorithmic decision-making system for the at least the subset of the set of inputs, a conditional probability of the outcome for the individual of the population, the conditional probability of the outcome for the group of individuals of the population, or a ratio of conditional probabilities for outcomes for two different groups of individuals of the population analyzed by the algorithmic decision-making system.

24. The tangible computer readable storage medium of claim 20, the operations further comprising:
sampling the distribution of inputs of the population analyzed by the algorithmic decision-making system to facilitate generating the set of inputs comprising the input intervention distribution.

25. The tangible computer readable storage medium of claim 20, the operations further comprising:
determining average marginal influence for the at least one QII measure using aggregation measures comprising at least one of a Shapley value, a Banzhaf index, or a Deegan-Packel index.

26. The tangible computer readable storage medium of claim 20, the operations further comprising:
transmitting the set of inputs to the algorithmic decision-making system; and
receiving information representative of the behavior of the algorithmic decision-making system for the input intervention distribution.
